(19) United States
(12) Patent Application Publication
(10) Pub. No.: US 2011/0256384 A1
(43) Pub. Date: Oct. 20, 2011

(54) OPTICAL ELEMENT

(75) Inventors: Fumitake MATSUZAKI, Kamiina-gun (JP); Hiroshi MATSUMOTO, Chigasaki-shi (JP)

(73) Assignee: SEIKO EPSON CORPORATION, TOKYO (JP)

(21) Appl. No.: 13/081,127

(22) Filed: Apr. 6, 2011

(30) Foreign Application Priority Data
Apr. 15, 2010 (JP) 2010-093740
Mar. 1, 2011 (JP) 2011-044336

(51) Int. Cl. B32B 9/04; B32B 17/06

(52) U.S. Cl. 428/333; 428/447; 428/429

(57) ABSTRACT

An optical element includes: a first base member having transparency; a second base member having transparency; and a bonding layer that bonds the first base member and the second base member and is provided by a plasma polymerizing method, wherein the bonding layer includes a siloxane bond (Si—O), and a elimination group binded to the Si skeleton, and when a thickness of the bonding layer is d, a wavelength of transmitted light is λ, and a refractive index of the bonding layer at the wavelength λ is n, following expressions are satisfied:

n×d/λ={(M+1)/2}+α (1)

−0.1≦α≦+0.2 (2)

where, M is a natural number.

### BACKGROUND

1. Technical Field

The present invention relates to an optical element in which plural base members having transparency are bonded through a bonding layer.

2. Related Art

An optical element, such as a laminated wavelength plate, a polarizing plate or a diffraction grating, in which plural base members having transparency are bonded through a bonding layer is often used. The optical element is such that two or more base members opposite to each other are bonded through the bonding layer. Hitherto, although an adhesive is used as the bonding layer, there is a problem that wave aberration occurs due to the large thickness of the adhesive.

Japanese Patent No. 4,337,935 (patent document 1) is known as disclosing a technique to bond the base members without using the adhesive in order to solve the problem caused when the two base members are bonded using the adhesive.

This patent document 1 discloses the technique in which plural plate-like substrates are bonded using a bonding layer which is formed on the surface of the substrate by a plasma polymerizing method and is activated. That is, the bonding layer is formed by the plasma polymerizing method, and includes a Si skeleton including a siloxane bond and having a crystallinity of 45% or less, and a elimination group binded to the Si skeleton and including an organic group. The bonding layer has an adhesive property caused when energy is imparted and the leaving group existing in the vicinity of the surface is eliminated from the Si skeleton.

JP-A-2009-098465 (patent document 2) proposes a polarizing plate in which a glass substrate and a polarizing film are bonded through the above bonding layer by using the bonding technique proposed in patent document 1.

JP-A-2009-258404 (patent document 3) discloses a laminated wavelength plate in which two quartz substrates are bonded through the bonding layer by using the bonding technique proposed in patent document 1.

JP-A-2010-060770 (patent document 4) proposes a polarization beam splitter in which the bonding technique proposed in patent document 1 is used, SiO₂ of an intermediate layer of a polarization separation film made of a multilayer film is used as a part of the bonding layer, a first translucent substrate on which a first multilayer film with the first bonding layer as the uppermost layer is formed and a second translucent substrate on which a second multilayer film with the second bonding layer as the uppermost layer is formed are integrated by molecularly bonding the first and the second bonding layer, and the first multilayer film and the second multilayer film are laminated to construct the polarization separation film.

However, in the related art bonding technique proposed in patent document 1 to patent document 4, a transmission characteristic caused when the refractive index is different between the bonding layer made of the plasma polymerized layer and the substrate is not discussed in detail.

That is, there arises a problem that light passing through the optical element and light multiple-reflected in the bonding layer interfere with each other due to the difference in refractive index between the bonding layer and the substrate, and the transmittance of the transmitted light is lowered. For example, the laminated wavelength plate proposed in patent document 3 is the optical element in which the two quartz substrates are bonded through the bonding layer made of the plasma polymerized film. Since the refractive index varies between the quartz crystal substrate and the bonding layer, multiple reflection is caused in the transmitted light passing through the laminated wavelength plate at the boundary surface (interface) between the bonding layer and the quartz crystal substrate, so that a loss occurs and the transmittance is lowered.

### SUMMARY

An advantage of some aspects of the invention is to provide an optical element in which reduction in transmittance of light passing through a bonding layer can be prevented.

### Application Example 1

This application example of the invention is directed to an optical element including a first base member having transparency, a second base member having transparency, and a bonding layer that bonds the first base member and the second base member and is provided by a plasma polymerizing method. The bonding layer includes a siloxane bond (Si—O), a Si skeleton having a crystallinity of 45% or less, and a leaving group bonded to the Si skeleton. The leaving group includes an organic group. The bonding layer has an adhesive property caused by elimination of the leaving group from the Si skeleton when energy is imparted to at least a partial area of the bonding layer. When a thickness of the bonding layer is d, a wavelength of transmitted light is λ, and a refractive index of the bonding layer at the wavelength λ is n, following expressions are satisfied

n×d/λ={(M+1)/2}+α (1)

−0.1≦α≦+0.2 (2)

where, M is a natural number.

In this application example, attention is paid to a fact that the wavelength λ of the transmitted light, the refractive index n at the wavelength λ and the thickness d of the bonding layer have a specific relation, and the expression (1) and the expression (2) are derived. The constant M is set according to the region of the wavelength λ to be used, and the number of peaks of the transmittance in the region. For example, when the wavelength λ varies, the number of peaks of the transmittance varies, and the value of the constant M to be set varies according to the number.

Thus, in this application example, the constant M is set according to the wavelength λ, and the constant M, the wavelength λ and the refractive index n are substituted in the expression (1), and further, the range of the thickness d of the bonding layer is obtained from the expression (2). Consequently, the transmittance becomes high for the wavelength to be used. Further, since the bonding layer is formed by the plasma polymerizing method, high resistance to light is obtained, and the optical element suitable for elongation of life can be provided.

### Application Example 2

This application example of the invention is directed to the optical element, wherein each of the first base member and the second base member has a birefringence.

In this application example, since the material having the birefringence is used for the base member, even in the optical element such as a wavelength plate, a polarizing plate or a diffraction grating, the transmittance can be made high.

### Application Example 3

This application example of the invention is directed to the optical element, wherein each of the first base member and the second base member is made of quartz crystal.

In this application example, since each of the first base member and the second base member is made of the quartz crystal which can be obtained relatively easily, it can be obtained inexpensively as compared with a material having a birefringence, such as sapphire.

### Application Example 4

This application example of the invention is directed to optical element, wherein when the wavelength 2 is in a 405 nm band, and the refractive index n is 1.5269, M is one of 0, 1 and 2.

In this application example, the constant M is one of 0, 1 and 2 according to the number P of peaks of the transmittance. When the constant M is 0, the optimum value of the thickness d of the bonding layer is in the range of from 106 nm to 186 nm. When the constant M is 1, the optimum value of the thickness d of the bonding layer is in the range of from 239 nm to 319 nm. When the constant M is 2, the optimum value of the thickness d of the bonding layer is in the range of from 372 nm to 452 nm.

In this application example, although all the thicknesses d of the three examples can be adopted, one preferable value of these is selected.

In this application example, the expression (2) is preferably −0.1≦α≦0.1. According to this expression, when the constant M is 0, the optimum value of the thickness d of the bonding layer is in the range of from 106 nm to 160 nm. When the constant M is 1, the optimum value of the thickness d of the bonding layer is in the range of from 239 nm to 293 nm. When the constant M is 2, the optimum value of the thickness d of the bonding layer is in the range of from 372 nm to 426 nm.

Incidentally, in this application example, the 405 nm band of the wavelength λ is the wavelength range used in Blu-ray. The wavelength λ is not strictly limited to 405 nm, and the band is the wavelength range of 405 nm±10 nm. In the above numerical values, 406 nm is used as the wavelength λ.

### Application Example 5

This application example of the invention is directed to the optical element, wherein when the wavelength λ is in a 660 nm band, and the refractive index n is 1.4950, the constant M is one of 0 and 1.

In this application example, the constant M is one of 0 and 1 according to the number P of peaks of the transmittance. When the constant M is 0, the thickness d of the bonding layer is in the range of from 173 nm to 302 nm. When the constant M is 1, the thickness d of the bonding layer is in the range of from 389 nm to 518 nm. In this case, although both the thicknesses d of the two examples can be adopted, one preferable value is selected.

In this application example, the expression (2) is preferably −0.1≦α≦0.1. According to this expression, when the constant M is 0, the thickness d of the bonding layer is in the range of from 173 nm to 259 nm. When the constant M is 1, the thickness d of the bonding layer is in the range of from 389 nm to 475 nm.

Incidentally, in this application example, the 660 nm band of the wavelength λ is the wavelength range used in DVD. The wavelength λ is not strictly limited to 660 nm, and the band is the wavelength range of 660 nm±15 nm. In the above numerical values, 660 nm is used as the wavelength λ.

### Application Example 6

This application example of the invention is directed to the optical element, wherein when the wavelength λ is in a 785 nm band, and the refractive index n is 1.4944, the constant M is 0.

In this application example, the constant M is 0 according to the number P of peaks of the transmittance. The thickness d of the bonding layer is in the range of from 210 nm to 368 nm.

In this application example, the expression (2) is preferably −0.1≦α≦0.1. According to this expression, the thickness d of the bonding layer is in the range of from 210 nm to 315 nm.

Incidentally, in this application example, the 785 nm band of the wavelength λ is the wavelength range used in CD. The wavelength λ is not strictly limited to 785 nm, and the band is the wavelength range of 785 nm 20 nm. In the above numerical values, 786 nm is used as the wavelength λ.

### Application Example 7

This application example of the invention is directed to the optical element, wherein when the wavelength λ is in a 354 nm band, and the refractive index n is 1.5899, the constant M is one of 1, 2 and 3.

In this application example, the constant M is one of 1, 2 and 3 according to the number P of peaks of the transmittance. When the constant M is 1, the thickness d of the bonding layer is in the range of from 201 nm to 268 nm. When the constant M is 2, the thickness d of the bonding layer is in the range of from 312 nm to 379 nm. When the constant M is 3, the thickness d of the bonding layer is in the range of from 424 nm to 491 nm. In this case, although all the thicknesses d of the three examples can be adopted, one preferable value is selected.

In this application example, the expression (2) is preferably −0.1≦α≦0.1. According to this expression, when the constant M is 1, the thickness d of the bonding layer is in the range of from 201 nm to 245 nm. When the constant M is 2, the thickness d of the bonding layer is in the range of from 312 nm to 359 nm. When the constant M is 3, the thickness d of the bonding layer is in the range of from 424 nm to 468 nm.

Incidentally, in this application example, in the 354 nm band of the wavelength λ, the wavelength λ is not strictly limited to 354 nm. In the above numerical values, 354 nm is used as the wavelength λ.

### Application Example 8

This application example of the invention is directed to the optical element, wherein when the wavelength λ is in a 532 nm band, and the refractive index n is 1.4982, the constant M is one of 0 and 1.

In this application example, the constant M is one of 0 and 1 according to the number P of peaks of the transmittance. When the constant M is 0, the thickness d of the bonding layer is in the range of from 142 nm to 249 nm. When the constant. M is 1, the thickness d of the bonding layer is in the range of from 320 nm to 426 nm. Although both the thicknesses d of the two examples can be adopted, one preferable value is selected.

In this application example, the expression (2) is preferably −0.1≦α≦0.1. According to this expression, when the constant M is 0, the thickness d of the bonding layer is in the range of from 142 nm to 213 nm. When the constant M is 1, the thickness d of the bonding layer is in the range of from 320 nm to 391 nm.

Incidentally, in this application example, in the 532 nm band of the wavelength λ, the wavelength λ is not strictly limited to 532 nm. In the above numerical values, 532 nm is used as the wavelength λ.

### Application Example 9

This application example of the invention is directed to the optical element, wherein when the wavelength is in a 1064 nm band, and the refractive index n is 1.4943, the constant M is 0.

In this application example, the constant M is 0 according to the number P of peaks of the transmittance. The thickness d of the bonding layer is in the range of from 285 nm to 498 nm.

In this application example, the expression (2) is preferably −0.1≦α≦0.1. According to this expression, the thickness d of the bonding layer is in the range of from 285 nm to 427 nm.

Incidentally, in this application example, in the 1064 nm band of the wavelength λ, the wavelength λ is not strictly limited to 1064 nm. In the above numerical values, 1064 nm is used as the wavelength λ.

### Application Example 10

This application example of the invention is directed to the optical element, wherein when the wavelength λ is in a 308 nm band, and the refractive index n is 1.7800, the constant M is one of 2, 3 and 4.

In this application example, the constant M is one of 2, 3 and 4 according to the number P of peaks of the transmittance. When the constant M is 2, the thickness d of the bonding layer is in the range of from 242 nm to 294 nm. When the constant M is 3, the thickness d of the bonding layer is in the range of from 329 nm to 381 nm. When the constant M is 4, the thickness d of the bonding layer is in the range of from 415 nm to 467 nm. In this case, although all of the thicknesses d of the three examples can be adopted, one preferable value is selected.

Incidentally, in this application example, in the 308 nm band of the wavelength λ, the wavelength λ is not strictly limited to 308 nm. In the above numerical values, 308 nm is used as the wavelength λ.

### BRIEF DESCRIPTION OF THE DRAWINGS

The invention will be described with reference to the accompanying drawings, wherein like numbers reference like elements.

FIG. 1 is a schematic view of an optical element of a first embodiment of the invention.

FIG. 2 is a schematic structural view of a plasma polymerizing apparatus.

FIGS. 3A to 3D are views for explaining a state where a plasma polymerized film is formed on a base member.

FIG. 4A is a schematic view for explaining a molecular structure before energy is imparted to a plasma polymerized film, and FIG. 4B is a schematic view for explaining the molecular structure after the energy is imparted to the plasma polymerized film.

FIGS. 5A to 5D are schematic views for explaining a procedure of manufacturing an optical element.

FIG. 6 is a graph showing a relation between a wavelength and a transmittance in a Blu-ray region.

FIG. 7 is a graph showing a relation between a wavelength and a transmittance in a DVD/CD region.

FIG. 8 is a graph showing a relation between a wavelength and a refractive index.

FIG. 9 is a graph showing a relation between a thickness of a bonding layer and a transmittance of the bonding layer when a wavelength λ is in a Blu-ray region.

FIG. 10 is a graph showing a relation between a thickness of a bonding layer and a transmittance of the bonding layer when a wavelength λ is in a DVD region.

FIG. 11 is a graph showing a relation between a thickness of a bonding layer and a transmittance of the bonding layer when a wavelength λ is in a CD region.

FIG. 12 is a graph showing a relation between a thickness of a bonding layer and a transmittance of the bonding layer when a wavelength λ is in a 354 nm band in a second embodiment of the invention.

FIG. 13 is a graph showing a relation between a thickness of a bonding layer and a transmittance of the bonding layer when a wavelength λ is in a 532 nm band in the second embodiment.

FIG. 14 is a graph showing a relation between a thickness of a bonding layer and a transmittance of the bonding layer when a wavelength λ is in a 1064 nm band in the second embodiment.

FIG. 15 is a graph showing a relation between a thickness of a bonding layer and a transmittance of the bonding layer when a wavelength λ is in a 308 nm band in a third embodiment of the invention.

### DESCRIPTION OF EXEMPLARY EMBODIMENTS

Hereinafter, embodiments of the invention will be described with reference to the drawings. Here, in the description of the respective embodiments, the same component is denoted by the same reference numeral and its explanation is omitted or simplified.

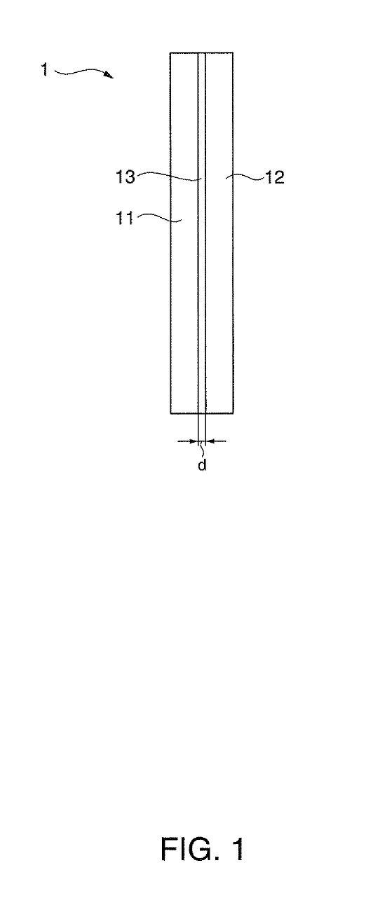

A first embodiment of the invention will be described with reference to FIG. 1 to FIG. 11. The first embodiment is an example in which an optical element is a laminated wavelength plate.

FIG. 1 is a schematic structural view of the optical element. The laminated wavelength plate is used for, for example, an optical pickup apparatus or a projection type video apparatus such as a projector.

In FIG. 1, the optical element 1 is a laminate type optical element including a first base member 11 having transparency, a second base member 12 having transparency and a bonding layer 13 to bond the fist base member 11 and the second base member 12.

In the first embodiment, the first base member 11 and the second base member 12 are respectively made of a material having a birefringence, and are, for example, a first and a second wavelength plate made of quartz crystal. The optical element has a structure in which the two first and second wavelength plates are laminated so that their respective crystalline optical axes intersect with each other at a specified angle. Incidentally, as the crystalline material forming the wavelength plate, LiNbO₃ (lithium niobate), sapphire, BBO, calcite, YVO₄, KTP (potassium phosphate titanate: KTiOPO₄) and the like can be enumerated in addition to the quartz crystal.

In this embodiment, the bonding layer 13 is made of a plasma polymerized film.

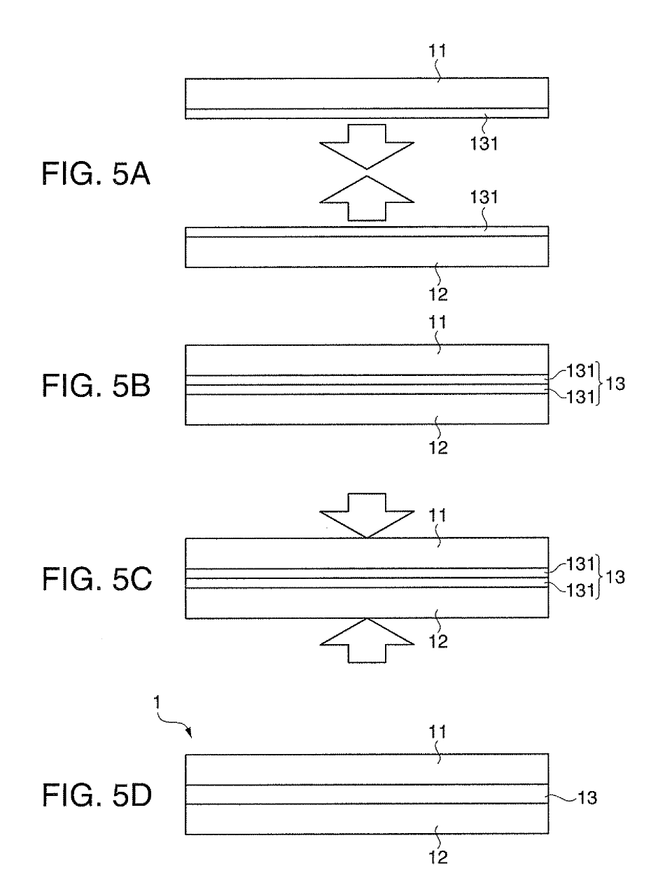

A plasma polymerized film 131 is provided on each of a bonding surface of the first base member 11 and a bonding surface of the second base member 12, and the plasma polymerized films 131 are mutually polymerized and the bonding layer 13 is formed (see FIGS. 5A to 5D).

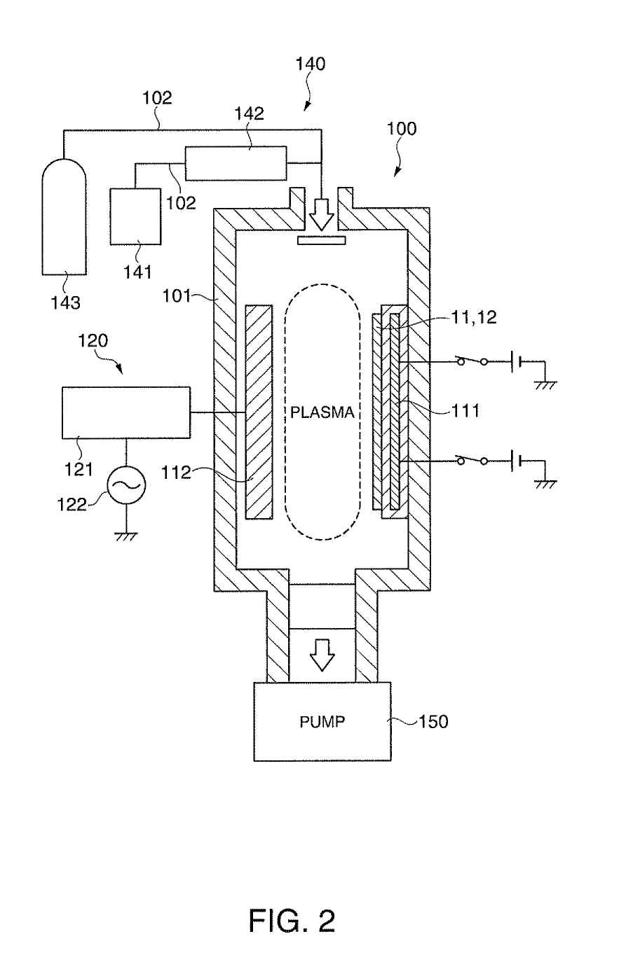

FIG. 2 is a schematic view of a plasma polymerizing apparatus used in this embodiment.

In FIG. 2, the plasma polymerizing apparatus 100 includes a chamber 101, a first electrode 111 and a second electrode 112 provided in the chamber 101, a power circuit 120 to apply a high frequency voltage between the first electrode 111 and the second electrode 112, a gas supply part 140 to supply a gas to the inside of the chamber 101, and an exhaust pump 150 to exhaust the gas from the inside of the chamber 101.

The power circuit 120 includes a matching box 121 and a high frequency power source 122. The gas supply part 140 includes a liquid storage part 141 for storing a liquid film material (raw material liquid), a vaporizing device 142 for vaporizing the liquid film material and changing it into a raw material gas, a gas bomb 143 for storing a carrier gas, and a pipe 102 for connect these. The carrier gas stored in the gas bomb 143 is the gas which is electrically discharged by the action of an electric field and is introduced into the chamber 101 in order to maintain the electric discharge, and is, for example, an argon gas or a helium gas.

The film material stored in the liquid storage part 141 is a raw material used by the plasma polymerizing apparatus 100 to form the plasma polymerized film 131 on the first base member 11 and the second base member 12. As the raw material gas, for example, organosiloxane such as methylsiloxane, hexamethyldisiloxane, octamethyltrisiloxane, decamethyltetrasiloxane, decamethylcyclopentasiloxane, octamethylcyclotetrasiloxane or methylphenylsiloxane is enumerated. Although polyorganosiloxane generally exhibits water repellency, an organic group can be easily eliminated by applying various activating processes, and the property can be changed to hydrophilic property.

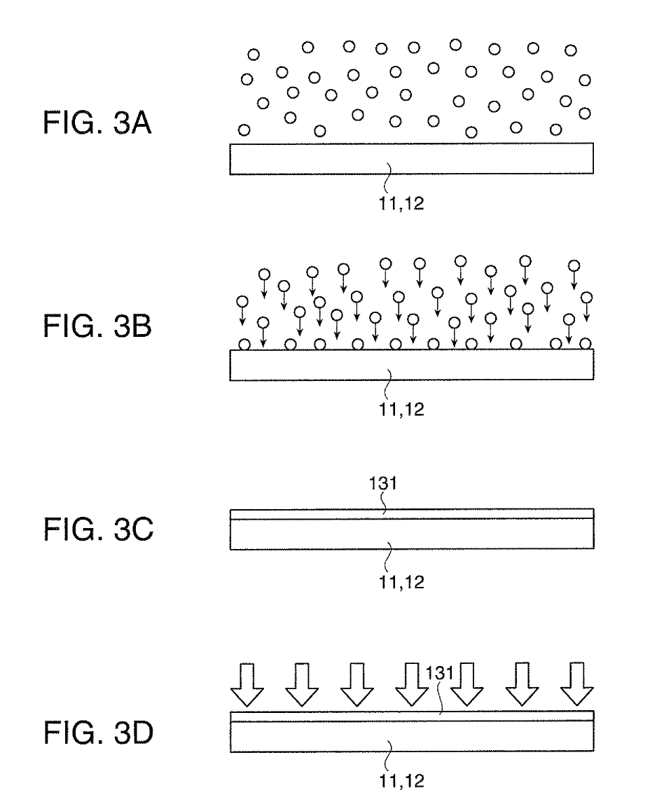

Next, a procedure of a manufacturing method of the optical element 1 in which the bonding layer 13 is formed of the plasma polymerized film 131 will be described with reference to FIG. 3A to FIG. 5D.

First, as shown in FIGS. 3A to 3C, the plasma polymerized film 131 is formed on the bonding surface of the first base member 11 and the second base member 12. In this process, the first base member 11 or the second base member 12 is held on the first electrode 111 of the plasma polymerizing apparatus 100, a specified amount of oxygen is introduced into the inside of the chamber 101, the power circuit 120 applies the high frequency voltage between the first electrode 111 and the second electrode 112, and the optical member itself is activated (substrate activation).

Thereafter, the gas supply part 140 is actuated, and the mixture gas of the raw material gas and the carrier gas is supplied to the inside of the chamber 101. The supplied mixture gas is filled in the inside of the chamber 101, and the first base member 11 or the second base member 12 is exposed to the mixture gas.

The high frequency voltage is applied between the first electrode 111 and the second electrode 112, so that gas molecules existing between the electrodes 111 and 112 are ionized, and plasma is generated. The molecules of the raw material gas are polymerized by the energy of the plasma, and as shown in FIG. 3B, the polymerized material is attached and deposited on the surface of the first base member 11 or the second base member 12. By this, as shown in FIG. 3C, the plasma polymerized film 131 is formed on the bonding surface of the first base member 11 or the second base member 12. Thereafter, as shown in FIG. 3D, energy is imparted to the plasma polymerized film 131 to activate the surface. In this step, for example, a method of irradiation with plasma, a method of contacting with an ozone gas, a method of treatment with ozone water, a method of treatment with an alkali, or the like can be used. In these, the method of irradiation with plasma is preferable in order to efficiently activate the surface of the plasma polymerized film 131. As the plasma, for example, one or two or more of oxygen, argon, nitrogen, air, water and the like are mixed and can be used.

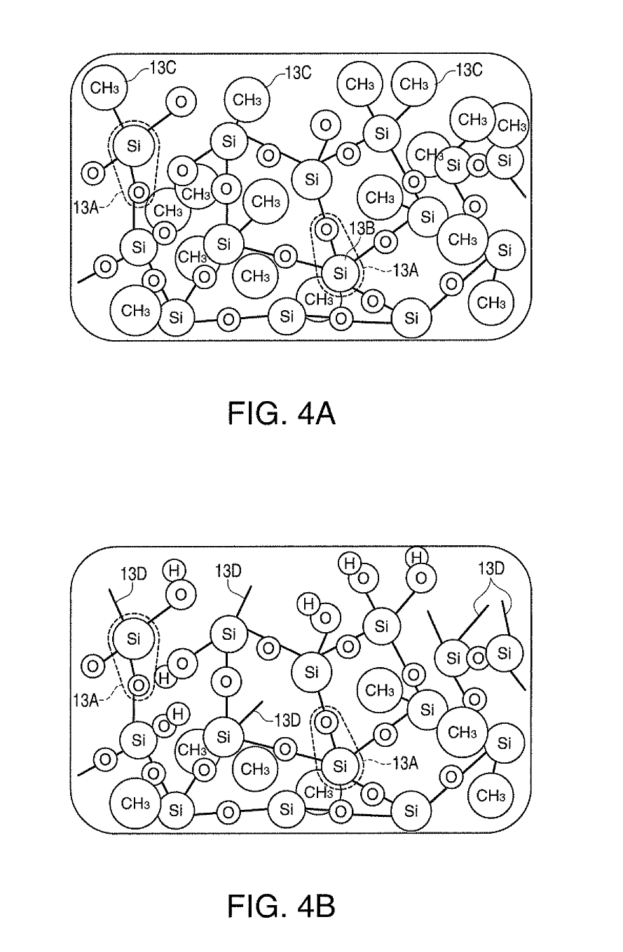

As shown in FIG. 4A, the plasma polymerized film 131 before the energy is imparted includes a Si skeleton 13B including a siloxane bond (Si—O) 13A and having a random atomic structure, and an elimination group 13C binded to the Si skeleton 133. The film becomes a firm film which is difficult to be deformed. It appears that this is because the crystallinity of the Si skeleton 13B becomes low, and defects such as dislocation and shear in crystal grain boundaries hardly occur. When energy is imparted to the plasma polymerized film 131 as stated above, as shown in FIG. 4B, dangling bonds 13D are generated on the surface and in the inside of the plasma polymerized film 131. By this, adhesive properties occur on the surface of the plasma polymerized film 131. When the adhesive properties occurs, the plasma polymerized films 131 can be firmly bonded to each other. Incidentally, the crystallinity of the Si skeleton 13B of the plasma polymerized film 131 is preferably 45% or less, and is more preferably 40% or less. This allows the Si skeleton 13B to have a sufficiently random atomic structure, and consequently, as mentioned above, the characteristics of the Si skeleton 13B become apparent.

The first base member 11 and the second base member 12, in which the surface of the plasma polymerized film 131 is activated, are stuck and integrated. That is, as shown in FIGS. 5A and 5B, the first base member 11 and the second base member 12 are pressed to each other in the state where the plasma polymerized films 131 are opposite to each other. The plasma polymerized films 131 are stuck to each other, so that these films are bonded.

As shown in FIG. 5C, after the sticking step, when necessary, the first base member 11 and the second base member 12 are pressurized. By this, as shown in FIG. 5D, the optical element 1 is manufactured. After the first base member 11 and the second base member 12 are pressurized, these are heated. By this heating, the bonding strength can be raised. Incidentally, the optical element 1 is appropriately diced.

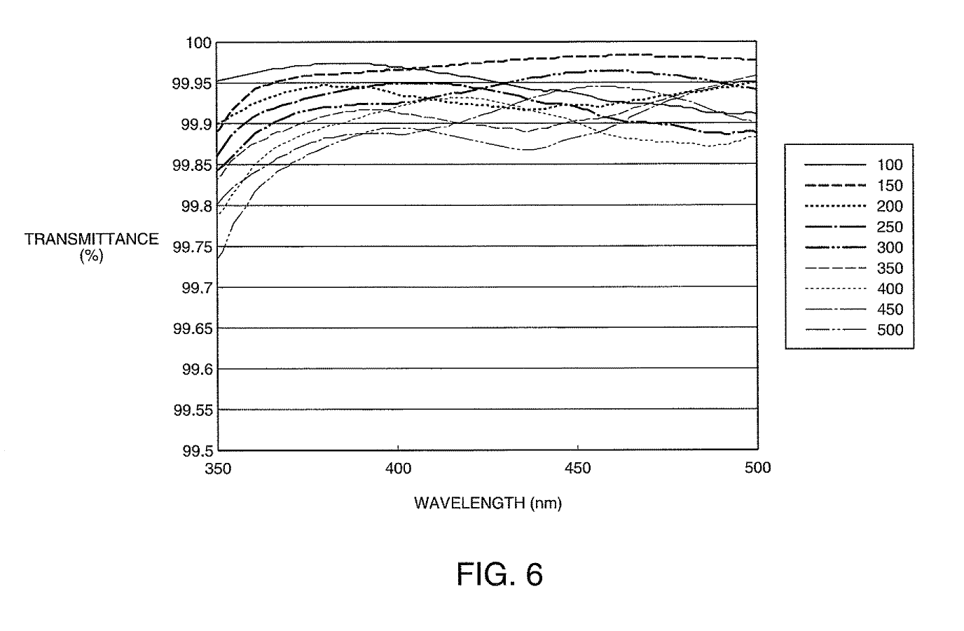

Next, a method of obtaining a thickness d of the bonding layer 13 in this embodiment will be described with reference to FIG. 6 to FIG. 11.

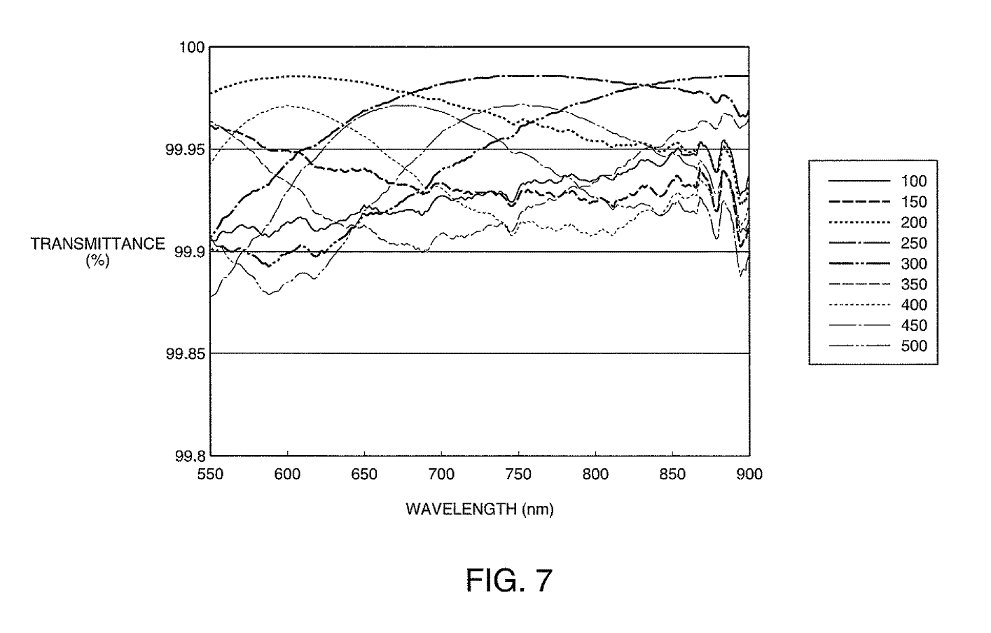

FIG. 6 is a graph showing a relation between a wavelength and a transmittance in a Blu-ray region. FIG. 7 is a graph showing a relation between a wavelength and a transmittance in a DVD and a CD region. FIG. 6 and FIG. 7 show the relation between the wavelength and the transmittance for the bonding layers 13 having the thicknesses d of from 100 nm to 500 nm at intervals of 50 nm. Incidentally, in the graphs of FIG. 6 and FIG. 7, it is assumed that there is no light reflected on the surface.

From FIG. 6 and FIG. 7, it is confirmed that the transmittance is changed according to the wavelength band and the thickness d of the bonding layer 13. As a factor causing the change of the transmittance, a light loss due to multiple reflection caused on the boundary surface between the bonding layer 13 and the first base member 11 and the boundary surface between the bonding layer 13 and the second base member 12 is conceivable.

From FIG. 6 and FIG. 7, it is understood that the transmittance is significantly changed by the magnitude of the thickness d irrespective of the wavelength.

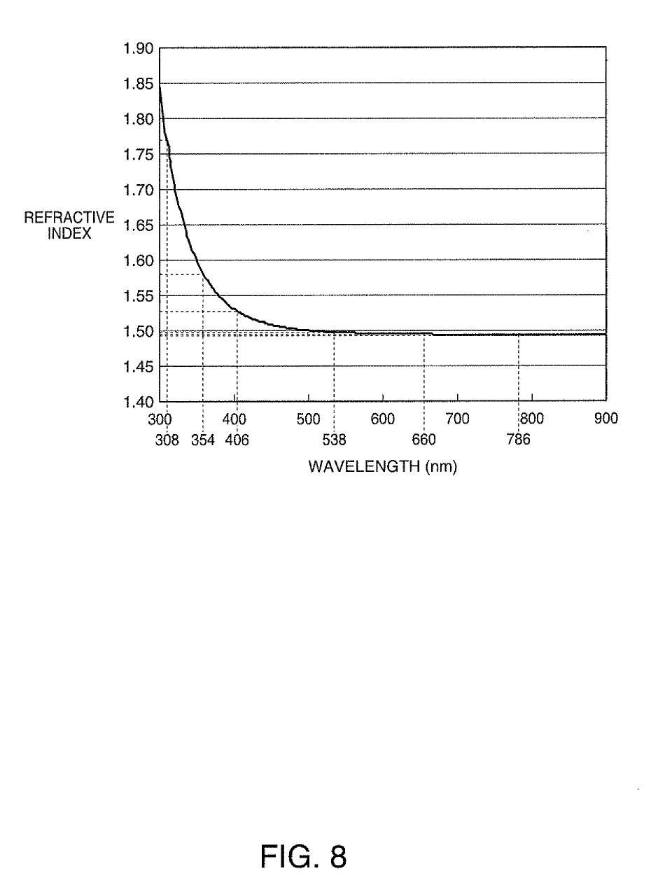

FIG. 8 is a graph showing a relation between a wavelength and a refractive index of the bonding layer 13. As shown in FIG. 8, it is understood that when the wavelength becomes 500 nm or less, the refractive index is abruptly increased, and the wavelength dispersion remarkably occurs. On the other hand, a large variation in refractive index is not observed at a long wavelength side exceeding 500 nm.

That is, it is found that in an optical element, such as a laminated wavelength plate, used in a Blu-ray region of a 405 nm band in which the wavelength is 500 nm or less or in an optical element for a laser oscillator using a YAG laser of a 354 nm band, there is a possibility that when the thickness of the bonding layer 13 is not strictly controlled, a desired optical characteristic can not be obtained.

It is supposed that the refractive index of the bonding layer 13 is changed by a manufacture condition (film formation condition). However, when the manufacture condition is almost optimized, it is conceivable that the refractive index does not become larger than the present value of the refractive index (refractive index-does not increase). Thus, the present inventor conceives that the lower limit value of the refractive index of the bonding layer 13 should be considered.

Further, the present inventor mainly pays attention to a short wavelength band not longer than 500 nm, and also attempts to optimize the bonding layer in view of the specifications on the long wavelength side as well as the short wavelength side.

Moreover, also in the thickness of the bonding layer 13, since it is found that the transmittance is significantly changed by the magnitude (thick/thin) of the thickness independently of the wavelength, the optimization is attempted also in view of this point.

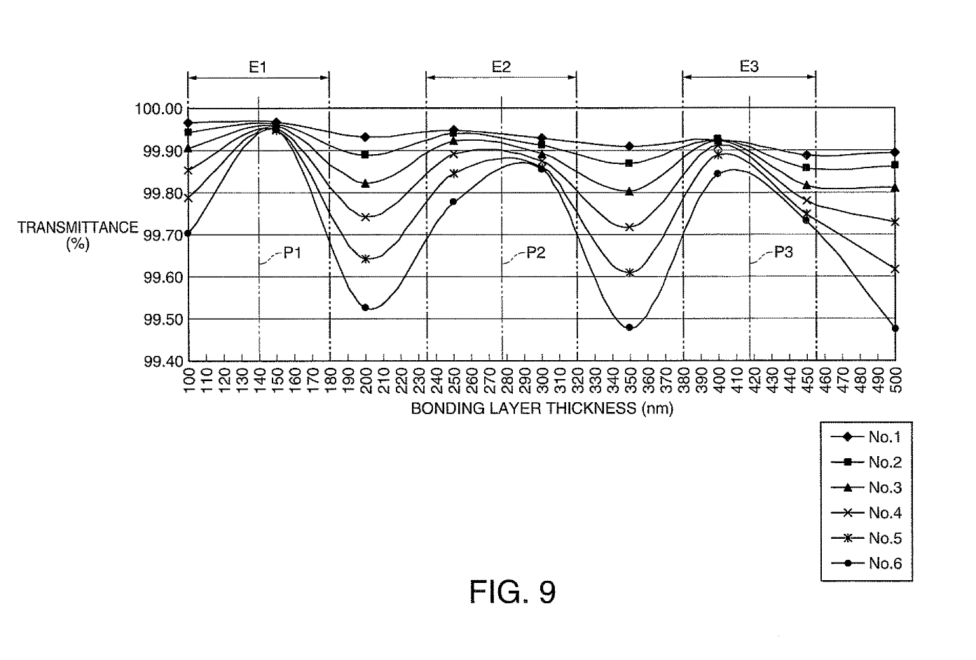

When the refractive index of the bonding layer 13 is changed from the reference value to values of −1% to −5%, the change of the transmittance caused by the change of the thickness of the bonding layer is examined by simulation. FIG. 9 to FIG. 11 show results of the simulation. From the result of FIG. 8, the refractive index of the bonding layer 13 is made a value at a wavelength λ of 500 nm or more at which the refractive index is not significantly changed, and the refractive index is set to a reference value (present value) and to values at which a lower limit rate is −1% to −5%. Incidentally, In FIG. 9 to FIG. 11, a case where the lower limit rate with respect to the reference value of the refractive index is 0 is indicated by No. 1, a case where the lower limit rate with respect to the reference value is −1% is indicated by No. 2, a case where the lower limit rate with respect to the reference value is −2% is indicated by No. 3, a case where the lower limit rate with respect to the reference value is −3% is indicated by No. 4, a case where the lower limit rate with respect to the reference value is −4% is indicated by No. 5, and a case where the lower limit rate with respect to the reference value is −5% is indicated by No. 6. Table 1 shows the relation between the lower limit rate and the refractive index in No. 1 to No. 6.

TABLE 1

| No. | Lower limit value | Refractive index |
|---|---|---|
| 1 | 0% | 1.4942 |
| 2 | −1% | 1.4793 |
| 3 | −2% | 1.4643 |
| 4 | −3% | 1.4494 |
| 5 | −4% | 1.4344 |
| 6 | −5% | 1.4195 |

Table 2 shows the result obtained when the transmittance of light with a wavelength λ=406 nm passing through the bonding layer 13 is examined by the simulation while the thickness of the bonding layer 13 is changed from 100 nm to 500 nm at steps of 50 nm.

TABLE 2

| Wavelength λ = 406 nm | | Bonding layer thickness (nm) | | | | | | | | |
|---|---|---|---|---|---|---|---|---|---|---|
| | Refractive index | 100 | 150 | 200 | 250 | 300 | 350 | 400 | 450 | 500 |
| No. 1 | 1.4942 | 99.97 | 99.97 | 99.93 | 99.95 | 99.93 | 99.91 | 99.93 | 99.89 | 99.89 |
| No. 2 | 1.4793 | 99.94 | 99.96 | 99.89 | 99.94 | 99.91 | 99.87 | 99.93 | 99.86 | 99.86 |
| No. 3 | 1.4643 | 99.91 | 99.96 | 99.82 | 99.92 | 99.89 | 99.80 | 99.92 | 99.82 | 99.81 |
| No. 4 | 1.4494 | 99.85 | 99.95 | 99.74 | 99.89 | 99.87 | 99.72 | 99.91 | 99.78 | 99.73 |
| No. 5 | 1.4344 | 99.79 | 99.95 | 99.64 | 99.85 | 99.86 | 99.61 | 99.89 | 99.75 | 99.62 |
| No. 6 | 1.4195 | 99.70 | 99.95 | 99.53 | 99.78 | 99.85 | 99.48 | 99.84 | 99.73 | 99.48 |

FIG. 9 is a graph based on the values of the transmittance of Table 2 and showing the result of the simulation showing the relation between the thickness of the bonding layer and the transmittance of the bonding layer when the wavelength λ is in the Blu-ray region. Incidentally, the wavelength λ used in the Blu-ray region is 405 nm±10 nm, and the transmittance of the bonding layer shown in FIG. 9 is the value at the wavelength λ=406 nm.

Table 3 shows the result obtained when the transmittance of light with a wavelength λ=660 nm passing through the bonding layer 13 is examined by the simulation while the thickness of the bonding layer 13 is changed from 100 nm to 500 nm at steps of 50 nm.

TABLE 3

| Wavelength λ = 660 nm | | Bonding layer thickness (nm) | | | | | | | | |
|---|---|---|---|---|---|---|---|---|---|---|
| | Refractive Index | 100 | 150 | 200 | 250 | 300 | 350 | 400 | 450 | 500 |
| No. 1 | 1.4942 | 99.92 | 99.94 | 99.98 | 99.97 | 99.92 | 99.91 | 99.95 | 99.97 | 99.93 |
| No. 2 | 1.4793 | 99.86 | 99.89 | 99.97 | 99.96 | 99.87 | 99.84 | 99.92 | 99.97 | 99.90 |
| No. 3 | 1.4643 | 99.77 | 99.82 | 99.96 | 99.96 | 99.81 | 99.75 | 99.88 | 99.97 | 99.87 |
| No. 4 | 1.4494 | 99.67 | 99.73 | 99.94 | 99.95 | 99.74 | 99.65 | 99.81 | 99.97 | 99.85 |
| No. 5 | 1.4344 | 99.54 | 99.62 | 99.91 | 99.95 | 99.67 | 99.51 | 99.72 | 99.96 | 99.84 |
| No. 6 | 1.4195 | 99.40 | 99.49 | 99.87 | 99.95 | 99.59 | 99.36 | 99.61 | 99.95 | 99.84 |

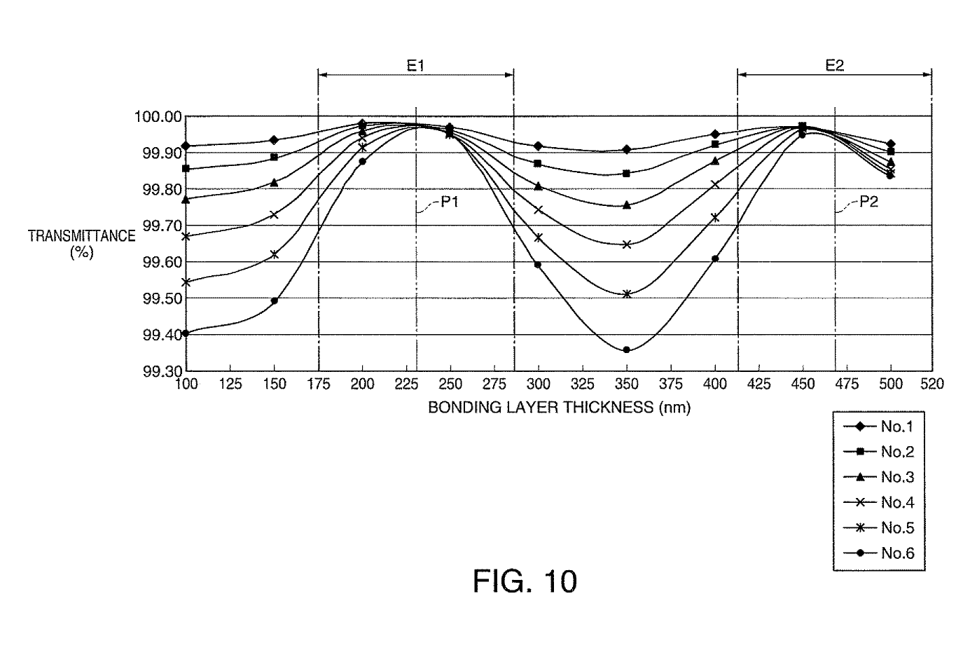

FIG. 10 is a graph of the simulation based on the values of the transmittance of Table 3 and showing the relation between the thickness of the bonding layer and the transmittance of the bonding layer when the wavelength λ, is in a DVD region. Incidentally, the wavelength λ, used in the DVD region is 660 nm±15 nm, and the transmittance of the bonding layer shown in FIG. 10 is the value at the wavelength λ=660 nm.

Table 4 shows the result obtained when the transmittance of light with a wavelength λ=786 nm passing through the bonding layer 13 is examined by the simulation while the thickness of the bonding layer 13 is changed from 100 nm to 500 nm at steps of 50 nm.

TABLE 4

| Wavelength λ = 784 nm | | Bonding layer thickness (nm) | | | | | | | | |
|---|---|---|---|---|---|---|---|---|---|---|
| | Refractive index | 100 | 150 | 200 | 250 | 300 | 350 | 400 | 450 | 500 |
| No. 1 | 1.4942 | 99.94 | 99.93 | 99.96 | 99.99 | 99.97 | 99.93 | 99.91 | 99.94 | 99.97 |
| No. 2 | 1.4793 | 99.89 | 99.87 | 99.93 | 99.98 | 99.96 | 99.89 | 99.85 | 99.89 | 99.96 |
| No. 3 | 1.4643 | 99.82 | 99.79 | 99.88 | 99.98 | 99.96 | 99.84 | 99.77 | 99.83 | 99.94 |
| No. 4 | 1.4494 | 99.73 | 99.69 | 99.82 | 99.97 | 99.95 | 99.78 | 99.67 | 99.74 | 99.91 |
| No. 5 | 1.4344 | 99.63 | 99.56 | 99.74 | 99.96 | 99.94 | 99.72 | 99.54 | 99.62 | 99.86 |
| No. 6 | 1.4195 | 99.51 | 99.41 | 99.65 | 99.94 | 99.94 | 99.65 | 99.41 | 99.48 | 99.79 |

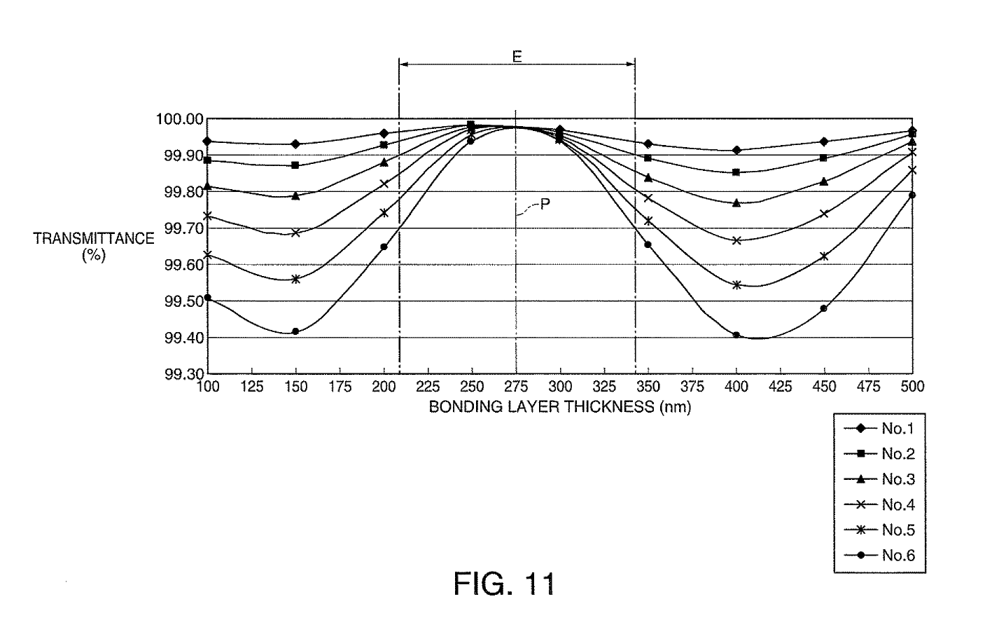

FIG. 11 is a graph of the simulation based on the values of the transmittance of Table 4 and showing the relation between the thickness of the bonding layer and the transmittance of the bonding layer when the wavelength λ, is in a CD region. Incidentally, the wavelength λ used in the CD region is 785 nm±20 nm, and the transmittance of the bonding layer shown in FIG. 11 is the value at the wavelength λ=786 nm.

A method of setting the optimum thickness d of the bonding layer 13 of the laminated wavelength plate when the use wavelength λ is 406 nm will be described with reference to FIG. 9.

The wavelength is 2, the refractive index of the bonding layer 13 at this wavelength λ is n, and the constant is M which is a natural number (M=0, 1, 2, . . . ).

In FIG. 9, the refractive index n is 1.5269. As is apparent from the graph of FIG. 9, a peak at which a difference in transmittance among the bonding layers 13 of No. 1 and No. 6 becomes small occurs three times, that is, there are a first-order peak P2, a second-order peak P2 and a third-order peak P2. Here, a relation between the constant M and the peak is M=P−1. That is, the constant M corresponding to the first-order peak P2 is 0, the constant M corresponding to the second-order peak P2 is 1, and the constant M corresponding to the third-order peak P2 is 2.

From the result of FIG. 9, for the respective peaks, as regions where the difference in transmittance among the bonding layers 13 of the refractive index No. 1 to No. 6 is small, the following values at three places are extracted as the value of the thickness d of the bonding layer.

peak 1: d=140.0 nm

peak 2: d=278.5 nm

peak 3: d=418.5 nm

At this time, the refractive index n of the bonding layer 13 at the wavelength λ=406 nm is n=1.5269 from FIG. 8

TABLE 5

| | Bonding layer thickness (nm) | nd | nd/λ |
|---|---|---|---|
| Peak 1 | 140.0 | 213.76 | 0.53 |
| Peak 2 | 278.5 | 425.23 | 1.05 |
| Peak 3 | 418.5 | 638.99 | 1.57 |

nd: optical film thickness

Thus, the optical film thickness nd at the peak 1 is obtained as described below.
d=140.0 nm, n=1.5269
nd=n×d=1.5269×140.0=213.766
When nd is normalized by the wavelength λ (=405 nm), nd/λ=213.766/405=0.5278=0.53

Similarly, the optical film thickness nd at the peak 2 is obtained as described below.
d=278.5 nm, n=1.5269
nd=n×d=1.5269×278.5=425.241
When nd is normalized by the wavelength λ, (=405 nm), nd/λ=425.241/405=1.049=1.05

Similarly, the optical film thickness nd at the peak 3 is obtained as described below.
d=418.5 nm, n=1.5269
nd=n×d=1.5269×418.5=639.007
When nd is normalized by the wavelength λ (=405 nm), nd/λ=639.007/405=1.577=1.57

Accordingly, it is conceived that when the bonding layer 13 is set so as to satisfy the following expressions, multiple reflection in the bonding layer 13 can be suppressed.

n×d/λ={(M+1)/2}+α (1)

−0.1≦α≦0.1 (2A)

Where, λ (nm) denotes the wavelength, n denotes the refractive index of the bonding layer 13 at the wavelength λ, and M denotes a natural number.

That is,

when peak 1: d=140.0 nm, then M=0, α=0.03

when peak 2: d=278.5 nm, then M=1, α=0.05

when peak 3: d=418.5 nm, then M=2, α=0.07

The thickness d corresponding to the first-order peak P2 is obtained from the expressions.

n×d/λ{(M+1)/2}+α (1)

−0.1≦α≦+0.1 (2A)

In the Blu-ray region, the wavelength λ is 406 nm, and the refractive index n corresponding to this wavelength λ is 1.5269 (see FIG. 8).

n×d/λ={(M+1)/2}+α

1.5269×d/406=1/2+α

d=(0.5+α)×(406/1.5269)≈(0.5+α)×266

0.4×266≦d≦0.6×266

106≦d≦160

The thickness d corresponding to the second-order peak P2 is obtained from the expressions.

n×d/λ={(M+1)/2}+α

1.5269×d/406=1+α

d=(1+α)×(406/1.5269)≈(1+α)×266

0.9×266≦d≦1.1×266

239≦d≦293

The thickness d corresponding to the third-order peak P2 is obtained from the expressions.

n×d/λ={(M+1)/2}+α

1.5269×d/406=1+α

d=(1.5+α)×(406/1.5269)≈(1.5+α)×266

1.4×266≦d≦1.6×266

372≦d≦426

In this embodiment, when the optical element is used only for the Blu-ray, a preferable value is appropriately set from the values of the thickness d in these three regions.

With reference to FIG. 9, it will be described that the thickness d obtained in these three regions is included in the region where the transmittance is high.

In FIG. 9, E1, E2 and E3 are set as the regions corresponding to the first-order peak P2 to the third-order peak P2. These regions E1, E2 and E3 are the regions where the transmittance has a value appropriate for a product, for example, 99.70% or more. The region E1 is an area where the thickness d of the bonding layer is 100 nm to 180 nm, and the thickness 150 nm at the first-order peak P2 obtained by the simulation is actually included in this region. The region E2 is an area where the thickness d is 237 nm to 320 nm, and the thickness 278.5 nm at the second-order peak P2 obtained by the simulation is actually included in this region. The region E3 is an area where the thickness d is 380 nm to 457 nm, and the thickness 418.5 nm at the third-order peak P2 obtained by the simulation is actually included in this region. When the thickness d obtained by the foregoing calculation is included in the ranges of the areas, it can be said that the foregoing calculation expressions are optimum.

The thickness d obtained correspondingly to the first-order peak P2 is from 106 nm to 160 nm, and the thickness 140 nm at the first-order peak P2 is included in this range. That is, when the thickness d of the bonding layer 13 is set in the range of from 106 nm to 160 nm, the thickness can be set to the thickness at which the highest transmittance at the first-order peak P2 is obtained or can be set to be close to the thickness.

Similarly, the thickness d obtained correspondingly to the second-order peak P2 is from 239 nm to 293 nm, and the thickness 278.5 nm at the second-order peak P2 is included in this range. That is, when the thickness d of the bonding layer 13 is set in the range of from 239 nm to 293 nm, the thickness can be set to the thickness at which the highest transmittance at the second-order peak P2 is obtained or can be set to be close to the thickness. The thickness d obtained correspondingly to the third-order peak P2 is from 372 nm to 426 nm, and the thickness 418.5 nm at the third-order peak P2 is included in this range. That is, when the thickness d of the bonding layer 13 is set in the range of from 372 nm to 426 nm, the thickness can be set to the thickness at which the highest transmittance at the third-order peak P2 is obtained or can be set to be close to the thickness.

From the result of FIG. 10, for the respective peaks, as regions where the difference in transmittance among the bonding layers 13 of the refractive index No. 1 to No. 6 is small, the following values at two places are extracted as the value of the thickness d of the bonding layer.

peak 1: d=227.5 nm

peak 2: d=466.0 nm

At this time, the refractive index n of the bonding layer 13 at the wavelength λ=660 nm is n=1.4950 from FIG. 8.

TABLE 6

| | Bonding layer thickness (nm) | nd | nd/λ |
|---|---|---|---|
| Peak 1 | 227.5 | 340.11 | 0.52 |
| Peak 2 | 466.0 | 696.66 | 1.06 |

nd: optical film thickness

Thus, the optical film thickness nd at the peak 1 is obtained as described below.
d=227.5 nm, n=1.4950
nd=n×d=1.4950×227.5=340.112
When nd is normalized by the wavelength λ (=405 nm), nd/2=340.112/660=0.51532=0.52

Similarly, the optical film thickness nd at the peak 2 is obtained as described below.
d=466.0 nm, n=1.4950
nd=n×d=1.4950×466.0=696.670
When nd is normalized by the wavelength λ (=405 nm), nd/λ=696.670/660=1.055=1.06

Accordingly, it is verified that when the bonding layer 13 is set so as to satisfy the following expressions, the multiple reflection in the bonding layer 13 can be suppressed.

n×d/λ={(M+1)/2}+α (1)

−0.1≦α≦+0.1 (2A)

Where, λ (nm) denotes the wavelength, n denotes the refractive index of the bonding layer 13 at the wavelength λ, and M denotes a natural number.

That is,

when peak 1: d=227.5 nm, then M=0, α=0.02

when peak 2: d=466.0 nm, then M=1, α0.06

A method of setting the optimum thickness of the bonding layer 13 of the laminated wavelength plate in which the wavelength λ to be used is 660 nm will be described with reference to FIG. 10.

In FIG. 10, the refractive index n is 1.4950. As is apparent from the graph of FIG. 10, a peak at which a difference in transmittance of the bonding layer 13 becomes small occurs twice, that is, there are a first-order peak P2 and a second-order peak P2. Here, a relation between the constant M and the peak is M=P−1. That is, the constant M corresponding to the first-order peak P2 is 0, and the constant M corresponding to the second-order peak P2 is 1.

The thickness d corresponding to the first-order peak P1 is obtained from the expressions.

n×d/λ={(M+1)/2}+α (1)

−0.1≦α≦0.1 (2A)

In the DVD region, the wavelength λ is 660 nm, and the refractive index n corresponding to this wavelength λ is 1.4950 (see FIG. 8).

n×d/λ={(M+1)/2}+α

1.4950×d/660=1/2+α

d=(0.5+α)×(660/1.5269)≈(0.5+α)×432

0.4×432≦d≦0.6×432

173≦d≦259

The thickness d corresponding to the second-order peak P2 is obtained from the expressions.

n×d/λ={(M+1)/2}+α

1.4950×d/660=1+α

d=(1+α)×(660/1.5269)≈(1+α)×432

0.9×432≦d≦1.1×432

389≦d≦475

In this embodiment, when the optical element is used only for the DVD, a preferable value is appropriately set from the values of the thickness d in these two regions.

With reference to FIG. 10, it will be described that the thickness d obtained in these two regions is included in the region where the transmittance is high.

In FIG. 10, E1 and E2 are set as regions corresponding to the first-order peak P2 and the second-order peak P2. These regions E1 and E2 are the regions where the transmittance has a value appropriate for a product, for example, 99.70% or more. The region E1 is an area where the thickness d of the bonding layer is 175 nm to 280 nm, and the thickness 227.5 nm at the first-order peak P2 is included in this region. The region E2 is an area where the thickness d is 412 nm to 520 nm, and the thickness 466 nm at the second-order peak P2 is included in this region. When the thickness d obtained by the foregoing calculation is included in the ranges of the areas, it can be said that the foregoing calculation expressions are optimum.

The thickness d obtained correspondingly to the first-order peak P2 is from 173 nm to 259 nm, and the thickness 227.5 nm at the first-order peak P2 is included in this range. The thickness d obtained correspondingly to the second-order peak P2 is from 389 nm to 475 nm, and the thickness 466 nm at the second-order peak P2 is included in this range.

From the result of FIG. 11, at the peak, as a region where the difference in transmittance among the bonding layers 13 of the refractive index No. 1 to No. 6 is small, the following value at one place is extracted as the value of the thickness d of the bonding layer.

peak 1: d=275.0 nm

At this time, the refractive index n of the bonding layer 13 at the wavelength λ=786 nm is n=1.4944 from FIG. 8.

TABLE 7

| | Bonding layer thickness (nm) | nd | nd/λ |
|---|---|---|---|
| Peak | 275 | 410.97 | 0.52 |

nd: optical film thickness

Thus, the optical film thickness nd at the peak is obtained as described below.
d=275.0 nm, n=1.4944
nd=n×d=1.4944×275.0=410.960
When nd is normalized by the wavelength λ (=405 nm), nd/λ=410.960/786=0.5228=0.52

Accordingly, it is verified that when the bonding layer 13 is set so as to satisfy the following expressions, the multiple reflection in the bonding layer 13 can be suppressed.

n×d/λ={(M+1)/2}+α (1)

−0.1≦α≦+0.1 (2A)

Where, λ (nm) denotes the wavelength, n denotes the refractive index of the bonding layer 13 at the wavelength λ, and M denotes a natural number.

That is,

when peak: d=275.0 nm, then M=0, α=0.02

A method of setting the optimum thickness of the bonding layer 13 of the laminated wavelength plate in which the wavelength λ to be used is 786 nm will be described with reference to FIG. 11.

In FIG. 11, the refractive index n is 1.4944. As is apparent from the graph of FIG. 11, a peak at which a difference in transmittance of the bonding layer 13 becomes small occurs once. Here, a relation between the constant M and the peak is M=P−1. That is, the constant M corresponding to the peak is 0.

The thickness d corresponding to the peak P is obtained from the expressions.

n×d/λ{(M+1)/2}+α (1)

−0.1≦α≦+0.1 (2A)

In the CD region, the wavelength λ is 786 nm, and the refractive index n corresponding to this wavelength λ is 1.4944 (see FIG. 8).

n×d/λ={(M+1)/2}+α

1.4944×d/786=1/2+α

d=(0.5+α)×(786/1.4944)≈(0.5+α)×526

0.4×526≦d≦0.6×526

210≦d≦315

With reference to FIG. 11, it will be described that the thickness d obtained in this region is included in the region where the transmittance is high.

In FIG. 11, E is set as a region corresponding to the peak. The region E is the region where the transmittance has a value appropriate for a product, for example, 99.70% or more. The region E is an area where the thickness d of the bonding layer is 210 nm to 340 nm, and the thickness 275 nm at the peak is included in this region. When the thickness d obtained by the foregoing calculation is included in the range of the area, it can be said that the foregoing calculation expressions are optimum.

The thickness d obtained correspondingly to the peak P is from 210 nm to 315 nm, and the thickness 275 nm at the peak is included in this range.

When the optical element 1 made of the laminated wavelength plate of this embodiment is made as a general-purpose product usable commonly to three types of the 406 nm band corresponding to the Blu-ray, the 660 nm band corresponding to the DVD, and the 786 nm band corresponding to the CD, the thickness d of the bonding layer 13 should be in a range common to the three types. That is, when the optical element 1 is made as the laminated wavelength plate common to the three wavelengths, the thickness d of the bonding layer 13 is from 239 nm to 259 nm.

Accordingly, in the first embodiment, the following operation and effects can be obtained.

(1) The bonding layer 13 that bonds the first base member 11 made of quartz crystal and the second base member 12 made of quartz crystal is formed by the plasma polymerizing method, and includes the Si skeleton including the siloxane bond (Si—O) and having the crystallinity of 45% or less, and the leaving group bonded to the Si skeleton and including the organic group. The bonding layer has the adhesive property caused by elimination of the leaving group existing in the vicinity of the surface from the Si skeleton when energy is imparted. When the wavelength is λ, the refractive index of the bonding layer 13 at the wavelength λ is n, and the constant is M (M=0, 1, 2, . . . ), the thickness d of the bonding layer 13 is obtained from the expression (1) of n×d/λ={(M+1)/2}+α and the expression (2A) of −0.1≦α≦0.1. Thus, the constant M is set, the constant M, the wavelength λ and the refractive index n are substituted in the expression (1), and the range of the thickness d of the bonding layer 13 can be obtained from the relation to the expression (2A). Accordingly, the optical element having the high transmittance can be provided according to the wavelength to be used.

(2) Since the optical element 1 is the laminated wavelength plate, the transmittance of the laminated wavelength plate can be made high.

(3) The wavelength λ, is 406 nm, the refractive index n is 1.5269, the constant M is one of 0, 1 and 2, and the thickness d of the bonding layer 13 is obtained from the foregoing expressions. The thickness is from 106 nm to 160 nm, from 239 nm to 293 nm, or from 372 nm to 426 nm. The thickness d of the bonding layer 13 is set in these ranges, so that the transmittance of the laminated wavelength plate corresponding to the Blu-ray can be made high.

(4) The wavelength λ is 660 nm, the refractive index n is 1.4950, the constant M is 0 or 1, and the thickness d of the bonding layer 13 is obtained from the foregoing expressions. The thickness is from 173 nm to 259 nm, or from 389 nm to 475 nm. The thickness d of the bonding layer 13 is set in these ranges, so that the transmittance of the laminated wavelength plate corresponding to the DVD can be made high.

(5) The wavelength λ is 786 nm, the refractive index n is 1.4944, the constant M is 0, and the thickness d of the bonding layer 13 is obtained from the foregoing expressions. The thickness is from 210 nm to 315 nm. The thickness d of the bonding layer 13 is set in this range, so that the transmittance of the laminated wavelength plate corresponding to the CD can be made high.

(6) When the thickness d of the bonding layer 13 in the laminated wavelength plate corresponding to the Blu-ray, the thickness d of the bonding layer 13 in the laminated wavelength plate corresponding to the DVD, and the thickness d of the bonding layer 13 in the laminated wavelength plate corresponding to the CD are set in the overlap range of from 239 nm to 259 nm, the general-purpose laminated plate corresponding to the three wavelength regions can be provided.

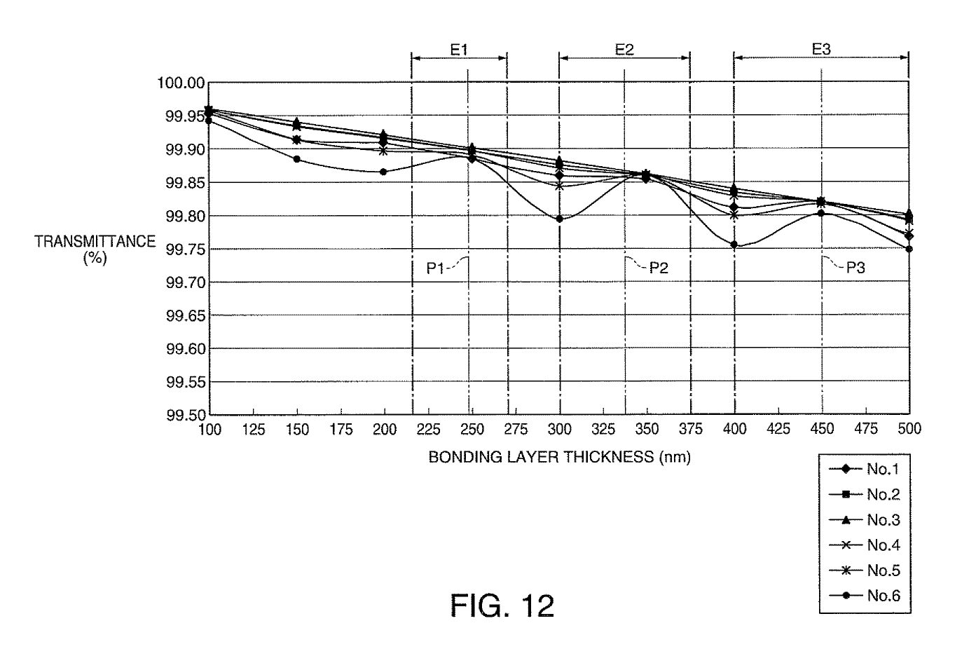

Next, a second embodiment of the invention will be described with reference to FIG. 12 to FIG. 14.

The second embodiment is an example in which an optical element is an optical element for YAG laser processing. Similarly to the laminated wavelength plate shown in FIG. 1, this optical element includes a first base member 11, a second base member 12 and a bonding layer 13 to bond the first base member 11 and the second base member 12. The thickness of this bonding layer 13 is d.

Since the optical element of the second embodiment is manufactured in the same way as the optical element 1 of the first embodiment, its description is omitted here.

Table 8 shows a result obtained when the transmittance of light with a wavelength λ=354 nm passing through the bonding layer 13 is examined by the simulation while the thickness of the bonding layer 13 is changed from 100 nm to 500 nm at steps of 50 nm.

TABLE 8

| | Refractive index | 100 | 150 | 200 | 250 | 300 | 350 | 400 | 450 | 500 |
|---|---|---|---|---|---|---|---|---|---|---|
| No. 1 | 1.4942 | 99.96 | 99.91 | 99.91 | 99.88 | 99.86 | 99.85 | 99.81 | 99.82 | 99.77 |
| No. 2 | 1.4793 | 99.96 | 99.93 | 99.92 | 99.90 | 99.88 | 99.86 | 99.83 | 99.82 | 99.79 |
| No. 3 | 1.4643 | 99.96 | 99.94 | 99.92 | 99.90 | 99.88 | 99.86 | 99.84 | 99.82 | 99.80 |
| No. 4 | 1.4494 | 99.96 | 99.93 | 99.91 | 99.90 | 99.87 | 99.86 | 99.83 | 99.82 | 99.79 |
| No. 5 | 1.4344 | 99.95 | 99.91 | 99.90 | 99.89 | 99.84 | 99.86 | 99.80 | 99.82 | 99.77 |
| No. 6 | 1.4195 | 99.94 | 99.89 | 99.86 | 99.88 | 99.79 | 99.86 | 99.76 | 99.80 | 99.75 |

FIG. 12 is a graph based on the values of the transmittance of Table 8 and showing the result of the simulation showing the relation between the thickness of the bonding layer and the transmittance of the bonding layer when the wavelength λ is in a 354 nm band.

Table 9 shows a result obtained when the transmittance of light with a wavelengthλ=532 nm passing through the bonding layer 13 is examined by the simulation while the thickness of the bonding layer 13 is changed from 100 nm to 500 nm at steps of 50 nm.

TABLE 9

| | Refractive index | 100 | 150 | 200 | 250 | 300 | 350 | 400 | 450 | 500 |
|---|---|---|---|---|---|---|---|---|---|---|
| No. 1 | 1.4942 | 99.91 | 99.97 | 99.97 | 99.90 | 99.91 | 99.97 | 99.92 | 99.87 | 99.93 |
| No. 2 | 1.4793 | 99.84 | 99.95 | 99.96 | 99.84 | 99.86 | 99.97 | 99.90 | 99.80 | 99.90 |
| No. 3 | 1.4643 | 99.75 | 99.92 | 99.96 | 99.76 | 99.78 | 99.96 | 99.87 | 99.71 | 99.84 |
| No. 4 | 1.4494 | 99.64 | 99.88 | 99.95 | 99.68 | 99.68 | 99.94 | 99.86 | 99.61 | 99.76 |
| No. 5 | 1.4344 | 99.51 | 99.83 | 99.95 | 99.58 | 99.55 | 99.92 | 99.85 | 99.49 | 99.64 |
| No. 6 | 1.4195 | 99.35 | 99.77 | 99.95 | 99.48 | 99.39 | 99.87 | 99.85 | 99.36 | 99.48 |

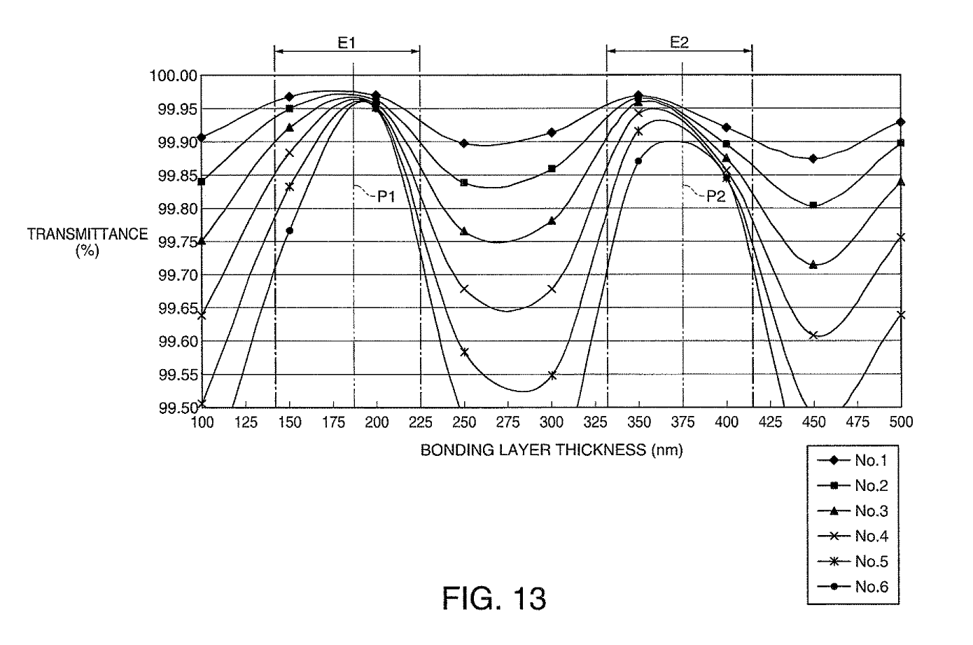

FIG. 13 is a graph based on the values of the transmittance of Table 9 and showing the result of the simulation showing the relation between the thickness of the bonding layer and the transmittance of the bonding layer when the wavelength λ is in a 532 nm band.

Table 10 shows a result obtained when the transmittance of light with a wavelengthλ=1064 nm passing through the bonding layer 13 is examined by the simulation while the thickness of the bonding layer 13 is changed from 100 nm to 500 nm at steps of 50 nm.

TABLE 10

| | Refractive index | 100 | 150 | 200 | 250 | 300 | 350 | 400 | 450 | 500 |
|---|---|---|---|---|---|---|---|---|---|---|
| No. 1 | 1.4942 | 99.99 | 99.99 | 99.98 | 99.98 | 99.99 | 99.99 | 99.98 | 99.98 | 99.97 |
| No. 2 | 1.4793 | 99.97 | 99.96 | 99.96 | 99.96 | 99.98 | 99.99 | 99.98 | 99.96 | 99.95 |
| No. 3 | 1.4643 | 99.95 | 99.91 | 99.91 | 99.93 | 99.96 | 99.98 | 99.98 | 99.94 | 99.91 |
| No. 4 | 1.4494 | 99.91 | 99.85 | 99.84 | 99.88 | 99.94 | 99.98 | 99.97 | 99.91 | 99.85 |
| No. 5 | 1.4344 | 99.85 | 99.76 | 99.74 | 99.81 | 99.91 | 99.98 | 99.97 | 99.88 | 99.78 |
| No. 6 | 1.4195 | 99.79 | 99.66 | 99.63 | 99.71 | 99.86 | 99.97 | 99.97 | 99.85 | 99.70 |

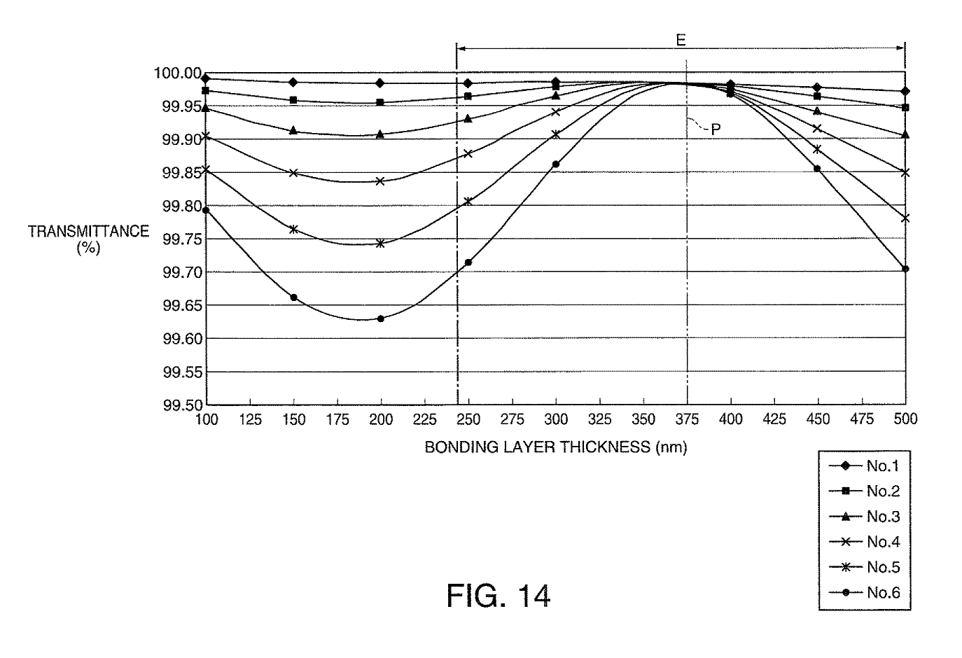

FIG. 14 is a graph based on the values of the transmittance of Table 10 and showing the result of the simulation showing the relation between the thickness of the bonding layer and the transmittance of the bonding layer when the wavelength λ is in a 1064 nm band.

A method of setting the optimum thickness of the bonding layer 13 of the optical element for oscillator which is used in the 354 nm band will be described with reference to FIG. 12.

In FIG. 12, the refractive index n is 1.5899. As is apparent from the graph of FIG. 12, a peak at which a difference in transmittance among the bonding layers 13 of No. 1 to No. 6 becomes small occurs three times, that is, there are a first-order peak P2, a second-order peak P2 and a third-order peak P2. Here, a relation between the constant M and the peak is M=P. That is, the constant M corresponding to the first-order peak P2 is 1, the constant M corresponding to the second-order peak P2 is 2, and the constant M corresponding to the third-order peak P2 is 3.

From the result of FIG. 12, for the respective peaks, as regions where the difference in transmittance among the bonding layers 13 of the refractive index No. 1 to No. 6 is small, the following values at three places are extracted as the value of the thickness d of the bonding layer.

peak 1: d=247.5 nm

peak 2: d=337.5 nm

peak 3: d=450 nm

At this time, the refractive index n of the bonding layer 13 at the wavelength λ=354 nm is n=1.5899 from FIG. 8.

TABLE 11

| | Bonding layer thickness (nm) | nd | nd/λ |
|---|---|---|---|
| Peak 1 | 247.5 | 393.5 | 1.11 |
| Peal 2 | 337.5 | 536.6 | 1.52 |
| Peak 3 | 450 | 715.4 | 2.02 |

nd: optical film thickness

Thus, the optical film thickness nd at the peak 1 is obtained as described below.
d=247.5 nm, n=1.5899
nd=n×d=1.5899×247.5 393.5
When nd is normalized by the wavelength λ (=354 nm), nd/λ=393.5/354≈1.11

Similarly, the optical film thickness nd at the peak 2 is obtained as described below.
d=337.5 nm, n=1.5899
nd=n×d=1.5899×337.5≈536.6
When nd is normalized by the wavelength λ (=354 nm), nd/λ=536.6/354≈1.52

Similarly, the optical film thickness nd at the peak 3 is obtained as described below.
d=450 nm, n=1.5899
nd=n×d=1.5899×450≈715.4
When nd is normalized by the wavelength λ (=354 nm), nd/λ=715.4/354≈2.02

Accordingly, it is conceived that when the bonding layer 13 is set so as to satisfy the following expressions, the multiple reflection in the bonding layer 13 can be suppressed.

n×d/λ={(M+1)/2}+α (1)

−0.1≦α≦+0.1 (2A)

Where, λ (nm) denotes the wavelength, n denotes the refractive index of the bonding layer 13 at the wavelength λ, and M denotes a natural number.

That is,

when peak 1: d=247.5 nm, then M=1, α=0.11

when peak 2: d=337.5 nm, then M=2, α=0.02

when peak 3: d=450 nm, then M=3, α=0.02

The thickness d corresponding to the first-order peak P2 is obtained from the expressions.

n×d/λ={(M+1)/2}+α (1)

−0.1≦α≦0.1 (2A)

The wavelength λ is 354 nm, and the refractive index n corresponding to this wavelength λ is 1.5899 (see FIG. 8).

n×d/λ={(M+1)/2}+α

1.5899×d/354=2/2+α

d=(1+α)×(354/1.5899)≈(1+α)×223

0.9×223≦d≦1.1×223

201≦d≦245

The thickness d corresponding to the second-order peak P2 is obtained from the expressions.

n×d/λ={(M+1)/2}+α

1.5899×d/354=1.5+α

d=(1.5+α)×(354/1.5899)≈(1.5+α)×223

1.4×223≦d≦1.6×223

312≦d≦359

The thickness d corresponding to the third-order peak P2 is obtained from the expressions.

n×d/λ={(M+1)/2}+α

1.5899×d/354=2+α

d=(2+α)×(354/1.5899)≈(2+α)×223

1.9×223≦d≦2.1×223

424≦d≦468

In this embodiment, when the optical element is used only for the 354 nm band, a preferable value is appropriately set from the values of the thickness d in these three regions.

With reference to FIG. 12, it will be described that the thickness d obtained in these three regions is included in the region where the transmittance is high.

In FIG. 12, E1, E2 and E3 are set as regions corresponding to the first-order peak P2 to the third-order peak P2. These regions E1, E2 and E3 are the regions where the transmittance has a value appropriate for a product, for example, 99.85% or more in the region E1, 99.80% or more in the region E2, and 99.75% or more in the region E3. The region E1 is an area where the thickness d of the bonding layer 13 is 220 nm to 270 nm, and the thickness 245 nm at the first-order peak P2 obtained by the simulation is included in this region. The region E2 is an area where the thickness d is 300 nm to 375 nm, and the thickness 337.5 nm at the second-order peak P2 obtained by the simulation is included in this region. The region E3 is an area where the thickness d is 400 nm to 500 nm, and the thickness 450 nm at the third-order peak P2 obtained by the simulation is included in this region. When the thickness d obtained by the foregoing calculation is included in the ranges of the areas, it can be said that the foregoing calculation expressions are optimum.

The thickness d obtained correspondingly to the first-order peak P2 is from 201 nm to 245 nm, and the thickness 245 nm at the first-order peak P2 is included in this range. The thickness d obtained correspondingly to the second-order peak P2 is from 312 nm to 359 nm, and the thickness 337.5 nm at the second-order peak P2 is included in this range. The thickness d obtained correspondingly to the third-order peak P3 is from 424 nm to 468 nm, and the thickness 450 nm at the third-order peak P2 is included in this range. As described above, the ranges of these thicknesses include the thickness at the peak, which is obtained by the simulation and at which the transmittance is highest. When the thickness of the bonding layer 13 is set in these ranges, the thickness can be set to the thickness at which the transmittance is highest or can be set to be close to the thickness.

A method of setting the optimum thickness of the bonding layer 13 of the optical element for oscillator which is used in the 532 nm band will be described with reference to FIG. 13.

As is apparent from the graph of FIG. 13, a peak at which a difference in transmittance among the bonding layers 13 becomes small occurs twice, that is, there are a first-order peak P2 and a second-order peak P2. Here, the relation between the constant M and the peak is M=P−1. That is, the constant M corresponding to the first-order peak P2 is 0, and the constant M corresponding to the second-order peak P2 is 1.

From the result of FIG. 13, for the respective peaks, as regions where the difference in transmittance among the bonding layers 13 of the refractive index No. 1 to No. 6 is small, the following values at two places are extracted as the value of the thickness d of the bonding layer.

peak 1: d=185.5 nm

peak 2: d ˜375.0 nm

At this time, the refractive index n of the bonding layer 13 at the wavelength λ=532 nm is n=1.4982 from FIG. 8.

TABLE 12

| | Bonding layer thickness (nm) | nd | nd/λ |
|---|---|---|---|
| Peak 1 | 185.5 | 277.9 | 0.52 |
| Peak 2 | 375.0 | 561.8 | 1.06 |

nd: optical film thickness

Thus, the optical film thickness nd at the peak 1 is obtained as described below.
d=185.5 nm, n=1.4982
nd=n×d=1.4982×185.5≈277.9
When nd is normalized by the wavelength λ (=532 nm), nd/2=277.9/532≈0.52

Similarly, the optical film thickness nd at the peak 2 is obtained as described below.
d=375.0 nm, n=1.4982
nd=n×d=1.4982×375.0≈561.8
When nd is normalized by the wavelength λ (=532 nm), nd/λ=561.8/532≈1.06

Accordingly, it is conceived that when the bonding layer 13 is set so as to satisfy the following expressions, the multiple reflection in the bonding layer 13 can be suppressed.

n×d/λ={(M+1)/2}+α (1)

−0.1≦α≦+0.1 (2A)

Where, λ (nm) denotes the wavelength, n denotes the refractive index of the bonding layer 13 at the wavelength λ, and M denotes a natural number.

That is,

when peak 1: d=185.5 nm, then M=0, α=0.02

when peak 2: d=375.0 nm, then M=1, α=0.06

The thickness d corresponding to the first-order peak P2 is obtained from the expressions.

n×d/λ={(M+1)/2}+α (1)

−0.1≦α≦0.1 (2A)

The wavelength λ is 532 nm, and the refractive index n corresponding to this wavelength λ is 1.4982 (see FIG. 8).

n×d/λ={(M+1)/2}+α

1.4982×d/532=1/2+α

d=(0.5+α)×(532/1.4982)≈(0.5+α)×355

0.4×355≦d≦0.6×355

142≦d≦213

The thickness d corresponding to the second-order peak P2 is obtained from the expressions.

n×d/λ={(M+1)/2}+α

1.4982×d/532=1.0+α

d=(1.0+α)×(532/1.4982)≈(1.0+α)×355

0.9×355≦d≦1.1×355

320≦d≦391

In this embodiment, when the optical element is used only for the 532 nm band, a preferable value is appropriately set from the values of the thickness d in these two regions.

With reference to FIG. 13, it will be described that the thickness d obtained in these two regions is included in the region where the transmittance is high.

In FIG. 13, E1 and E2 are set as regions corresponding to the first-order peak P2 and the second-order peak P2. These regions E1 and E2 are the regions where the transmittance has a value appropriate for a product, for example, 99.70% or more The region E1 is an area where the thickness d of the bonding layer 13 is 146 nm to 225 nm, and the thickness 185.5 nm at the first-order peak P2 obtained by the simulation is included in this region. The region E2 is an area where the thickness d is 330 nm to 420 nm, and the thickness 375 nm at the second-order peak P2 obtained by the simulation is included in this region. When the thickness d obtained by the foregoing calculation is included in the ranges of the areas, it can be said that the foregoing calculation expressions are optimum.

The thickness d obtained correspondingly to the first-order peak P2 from the foregoing expressions is from 142 nm to 213 nm, and the thickness 185.5 nm at the first-order peak P2 obtained by the simulation is included in this range. The thickness d obtained correspondingly to the second-order peak P2 is from 320 nm to 391 nm, and the thickness 375 nm at the second-order peak P2 is included in this range. As described above, the ranges of these thicknesses include the thickness at the peak, which is obtained by the simulation and at which the transmittance is highest. When the thickness of the bonding layer 13 is set in these ranges, the thickness can be set to the thickness at which the transmittance is highest or can be set to be close to the thickness.

A method of setting the optimum thickness of the bonding layer 13 of the optical element for oscillator which is used in the 1064 nm band will be described with reference to FIG. 14.

As is apparent from the graph of FIG. 14, a peak at which a difference in transmittance among the bonding layers 13 becomes small occurs once. Here, the relation between the constant M and the peak is M=P−1. That is, the constant M corresponding to the peak is 0.

From the result of FIG. 14, at the peak, as a region where the difference in transmittance among the bonding layers 13 of the refractive index No. 1 to No. 6 is small, the following value at one place is extracted as the value of the thickness d of the bonding layer.

peak: d=375.0 nm

At this time, the refractive index n of the bonding layer 13 at the wavelength λ=1064 nm is n=1.4943 from FIG. 8.

TABLE 13

| | Bonding layer thickness (nm) | nd | nd/λ |
|---|---|---|---|
| Peak | 375 | 560.3 | 0.53 |

nd: optical film thickness

Thus, the optical film thickness nd at the peak is obtained as described below.
d=375.0 nm, n=1.4943
nd=n×d=1.4943×375.0≈560.32
When nd is normalized by the wavelength λ (=1064 nm), nd/λ=560.32/1064≈0.53

Accordingly, it is verified that when the bonding layer 13 is set so as to satisfy the following expressions, the multiple reflection in the bonding layer 13 can be suppressed.

n×d/λ={(M+1)/2}+α (1)

−0.1≦α≦+0.1 (2A)

Where, λ (nm) denotes the wavelength, n denotes the refractive index of the bonding layer 13 at the wavelength λ, and M denotes a natural number.

That is,

when peak: d=375.0 nm, then M=0, α=0.03

With reference to FIG. 14, it will be described that the thickness d obtained in this region is included in the region where the transmittance is high.

In FIG. 14, E is set as a region corresponding to the peak P. This region E is the region where the transmittance has a value appropriate for a product, for example, 99.70% or more. The region E is an area where the thickness d of the bonding layer 13 is 248 nm to 500 nm, and the thickness 375 nm at the peak P obtained by the simulation is included in this region. When the thickness d obtained by the foregoing calculation is included in the range of this area, it can be said that the foregoing calculation expressions are optimum.

The thickness d obtained correspondingly to the peak P from the foregoing expressions is from 285 nm to 427 nm, and the thickness 375 nm at the peak P obtained by the simulation is included in this range. The range of the thickness obtained by the calculation includes the thickness at the peak, which is obtained by the simulation and at which the transmittance is highest. When the thickness of the bonding layer 13 is set in this range, the thickness can be set to the thickness at which the transmittance is highest or can be set to be close to the thickness.

When the optical element 1 formed of the optical element for YAG laser processing in this embodiment is made as a general-purpose product usable commonly to three types of the primary 354 nm band, the second-order 532 nm band and the third-order 1064 nm band, the thickness d of the bonding layer 13 should be in a range common to the three types. That is, when the optical element 1 is made as the optical element for YAG laser processing common to the three wavelengths, the thickness d of the bonding layer 13 is from 320 nm to 359 nm.

Accordingly, in the second embodiment, in addition to the same operation and effects as those of the first embodiment, the following operation and effects can be obtained.

(7) Since the optical element 1 is the optical element for YAG laser processing, the transmittance of the optical element for YAG laser processing can be made high.

(8) The wavelength λ is made 354 nm, the refractive index n is made 1.5899, the constant M is made 1, 2 or 3, and the thickness d of the bonding layer 13 is obtained from the foregoing expressions. The thickness is from 201 nm to 245 nm, from 312 nm to 359 nm or from 424 nm to 468 nm. When the thickness d of the bonding layer 13 is set in these ranges, the transmittance of the optical element for YAG laser processing corresponding to a laser oscillating apparatus used in the primary band, can be made high.

(9) The wavelength λ is made 532 nm, the refractive index n is made 1.4982, the constant M is made 0 or 1, and the thickness d of the bonding layer 13 is obtained from the foregoing expressions. The thickness is from 142 nm to 213 nm or from 320 nm to 391 nm. When the thickness d of the bonding layer 13 is set in these ranges, the transmittance of the optical element for YAG laser processing used in the secondary-order band can be made high.

(10) The wavelength λ is made 1064 nm, the refractive index n is made 1.4943, the constant M is made 0, and the thickness d of the bonding layer 13 is obtained from the foregoing expressions. The thickness is from 285 nm to 427 nm. When the thickness d of the bonding layer 13 is set in this range, the transmittance of the optical element for YAG laser processing used in the third-order band can be made high.

(11) When the thickness d of the bonding layer 13 of the optical element for YAG laser processing used in the primary band, the thickness d of the bonding layer 13 of the optical element for YAG laser processing used in the second-order band, and the thickness d of the bonding layer 13 of the optical element for YAG laser processing used in the third-order band are set in the overlap range of from 320 nm to 359 nm, the general-purpose optical element for YAG laser processing corresponding to the three wavelength ranges can be provided.

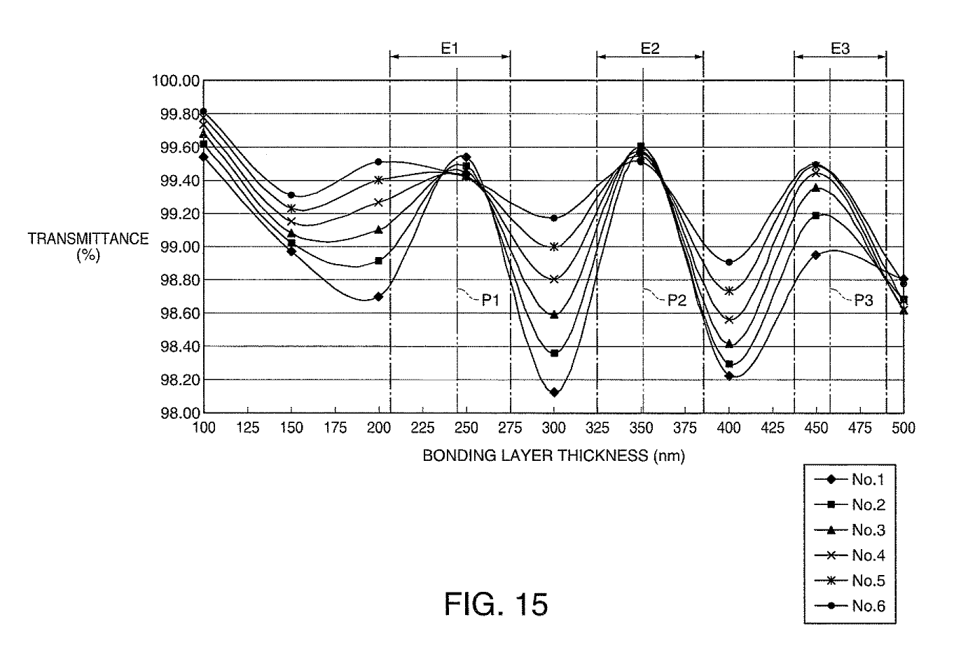

Next, a third embodiment of the invention will be described with reference to FIG. 15.

The third embodiment is an example in which an optical element is an optical element for xenon laser processing. Similarly to the laminated wavelength plate shown in FIG. 1, this optical element includes a first base member 11, a second base member 12 and a bonding layer 13 to bond the first base member 11 and the second base member 12. The thickness of this bonding layer 13 is d.

Since the optical element of the third embodiment is manufactured in the same way as the optical element 1 of the first embodiment, its description is omitted here.

Table 14 shows a result obtained when the transmittance of light with a wavelength λ=308 nm passing through the bonding layer 13 is examined by simulation while the thickness of the bonding layer 13 is changed from 100 nm to 500 nm at steps of 50 nm.

TABLE 14

| | Refractive index | 100 | 150 | 200 | 250 | 300 | 350 | 400 | 450 | 500 |
|---|---|---|---|---|---|---|---|---|---|---|
| No. 1 | 1.4942 | 99.54 | 98.97 | 98.70 | 99.54 | 98.12 | 99.58 | 98.22 | 98.95 | 98.80 |
| No. 2 | 1.4793 | 99.62 | 99.02 | 98.91 | 99.49 | 98.36 | 99.61 | 98.29 | 99.19 | 98.68 |
| No. 3 | 1.4643 | 99.68 | 99.08 | 99.10 | 99.45 | 98.59 | 99.60 | 98.41 | 99.35 | 98.62 |
| No. 4 | 1.4494 | 99.74 | 99.15 | 99.26 | 99.43 | 98.80 | 99.58 | 98.56 | 99.45 | 98.62 |
| No. 5 | 1.4344 | 99.78 | 99.23 | 99.40 | 99.42 | 99.00 | 99.54 | 98.74 | 99.49 | 98.68 |
| No. 6 | 1.4195 | 99.81 | 99.31 | 99.51 | 99.42 | 99.18 | 99.51 | 98.91 | 99.50 | 98.78 |

A method of setting the optimum thickness of the bonding layer 13 of the optical element used in a 308 nm band will be described with reference to FIG. 15.

In FIG. 15, the refractive index n is 1.7800. As is apparent from the graph of FIG. 15, a peak at which a difference in transmittance among the bonding layers 13 becomes small occurs three times, that is, there are a first-order peak P2, a second-order peak P2 and a third-order peak P2. Here, the relation between the constant M and the peak is M=P+1. That is, the constant M corresponding to the first-order peak P2 is 2, the constant M corresponding to the second-order peak P2 is 3, and the constant M corresponding to the third-order peak P2 is 4.

From the result of FIG. 15, for the respective peaks, as regions where the difference in transmittance among the bonding layers 13 of the refractive index No. 1 to No. 6 is small, the following values at three places are extracted as the value of the thickness d of the bonding layer.

peak 1: d=243.5 nm

peak 2: d=352.5 nm

peak 3: d=459.5 nm

At this time, the refractive index n of the bonding layer 13 at the wavelength λ=308 nm is n=1.7800 from FIG. 8.

TABLE 15

| | Bonding layer thickness (nm) | nd | nd/λ |
|---|---|---|---|
| Peak 1 | 243.5 | 433.4 | 1.40 |
| Peak 2 | 352.5 | 627.5 | 2.04 |
| Peak 3 | 459.5 | 817.9 | 2.66 |

nd: optical film thickness

Thus, the optical film thickness nd at the peak 1 is obtained as described below.
d ˜243.5 nm, n=1.7800
nd=n×d=1.7800×243.5 433.4
When nd is normalized by the wavelength λ(=308 nm), nd/λ=433.4/308≈1.40

Similarly, the optical film thickness nd at the peak 2 is obtained as described below.
d=352.5 nm, n=1.7800
nd=n×d=1.7800×352.5≈627.5
When nd is normalized by the wavelength λ (=308 nm), nd/λ=627.5/308≈2.04

Similarly, the optical film thickness nd at the peak 3 is obtained as described below.
d=459.5 nm, n=1.7800
nd=n×d=1.7800×459.5≈817.9
When nd is normalized by the wavelength λ (=308 nm), nd/λ=817.9/308≈2.66

Accordingly, it is conceived that when the bonding layer 13 is set so as to satisfy the following expressions, the multiple reflection in the bonding layer 13 can be suppressed.

n×d/λ={(M+1)/2}+α (1)

−0.1≦α≦0.1 (2A)

Where, λ (nm) denotes the wavelength, n denotes the refractive index of the bonding layer 13 at the wavelength λ, and M denotes a natural number.

That is,

when peak 1: d=243.5 nm, then M=2, α=−0.10

when peak 2: d=352.5 nm, then M=3, α=0.04

when peak 3: d=459.5 nm, then M=4, α=0.16

The thickness d corresponding to the first-order peak P2 is obtained from the expressions.

n×d/λ{(M+1)/2}+α (1)

−0.1≦α≦0.2 (2)

The wavelength λ is 308 nm, and the refractive index n corresponding to this wavelength λ is 1.7800 (see FIG. 8).

n×d/λ={(M+1)/2}+α

1.7800×d/308=3/2+α

d=(1.5+α)×(308/1.7800)≈(1.5+α)×173

1.4×173≦d≦1.7×173

242≦d≦294

The thickness d corresponding to the second-order peak P2 is obtained from the expressions.

n×d/λ={(M+1)/2}+α

1.7800×d/308=2+α

d=(2+α)×(308/1.7800)≈(2+α)×173

1.9×173≦d≦2.2×173

329≦d≦381

The thickness d corresponding to the third-order peak P2 is obtained from the expressions.

n×d/λ={(M+1)/2.5}+α

1.7800×d/308=2.5+α

d=(2.5+α)×(308/1.7800)≈(2.5+α)×173

2.4×173≦d≦2.7×173

415≦d≦467

In this embodiment, when the optical element is used only for the 308 nm band, a preferable value is appropriately set from the values of the thickness d in these three regions.

With reference to FIG. 15, it will be described that the thickness d obtained in these three regions is included in the region where the transmittance is high.

FIG. 15 is a graph showing the simulation of the relation between the thickness of the bonding layer and the transmittance of the bonding layer when the wavelength λ is in the 308 nm band.

As is apparent from the graph of FIG. 15, the peak at which the difference in transmittance among the bonding layers 13 is small occurs three times, that is, there are a first-order peak P2, a second-order peak P2 and a third-order peak P2. Here, the relation between the constant M and the peak is M=P+1. That is, the constant M corresponding to the first-order peak P2 is 2, the constant M corresponding to the second-order peak P2 is 3, and the constant M corresponding to the third-order peak P2 is 4.

In FIG. 15, E1, E2 and E3 are set as regions corresponding to the first-order peak P2 to the third-order peak P2. These regions E1, E2 and E3 are the regions where the transmittance has a value appropriate for a product, for example, 98.8% or more. The region E1 is an area where the thickness d of the bonding layer is 212 nm to 275 nm, and the thickness 243.5 nm at the first-order peak P2 obtained by the simulation is included in this region. The region E2 is an area where the thickness d is 325 nm to 380 nm, and the thickness 352.5 nm at the second-order peak P2 obtained by the simulation is included in this region. The region E3 is an area where the thickness d is 435 nm to 484 nm, and the thickness 459.5 nm at the third-order peak P2 obtained by the simulation is included in this region. When the thickness d obtained by the foregoing calculation is included in the ranges of the areas, it can be said that the foregoing calculation expressions are optimum.

The thickness d obtained correspondingly to the first-order peak P2 is from 242 nm to 294 nm, and the thickness 243.5 nm at the first-order peak P2 is included in this range. The thickness d obtained correspondingly to the second-order peak P2 is from 329 nm to 381 nm, and the thickness 352.5 nm at the second-order peak P2 is included in this range. The thickness d obtained correspondingly to the third-order peak P3 is from 415 nm to 467 nm, and the thickness 459.5 nm at the third-order peak P2 is included in this range. As described above, these ranges of the thicknesses include the thickness at the peak, which is obtained by the simulation and at which the transmittance is highest. When the thickness of the bonding layer 13 is set in these ranges, the thickness can be set to the thickness at which the transmittance is highest or can be set to be close to the thickness.

Accordingly, in the third embodiment, in addition to the same operation and effects as those of the first embodiment, the following operation and effects can be obtained.

(12) Since the optical element 1 is the optical element for xenon laser processing, the transmittance of the optical element for xenon laser processing can be made high.

Incidentally, the invention is not limited to the foregoing embodiments, and includes modifications described below within the range in which the object of the invention can be achieved.

For example, as the optical element, the laminated wavelength plate is described in the first embodiment, the optical element for YAG laser processing is described in the second embodiment, and the optical element for xenon laser processing is described in the third embodiment. However, the optical element of the invention is not limited to these. The optical element has only to be such that the first base member having transparency and the second base member having transparency are bonded by the bonding layer provided therebetween by the plasma polymerizing method, and may be, for example, an open filter or other optical elements.

In the first embodiment, the description is made on the example in which the optical element is the wavelength plate which is used for the optical pickup apparatus, and in which the first base member and the second base member made of material of quartz crystal are laminated. However, in the invention, it is needless to say that the material of the base member is not limited to the quartz crystal, and no limitation is made to the wavelength plate. That is, in the invention, instead of the quartz crystal, a crystalline material, such as sapphire, having a birefringence may be used, and further, instead of the crystalline material, a material merely having transparency may be used.

The optical element of the invention is not limited to one used for the optical pickup apparatus, and it is needless to say that the optical element is widely used for a projection type video apparatus, such as a projector, and other optical apparatuses.

In the respective embodiments, the plasma polymerized film 131 is formed on the main surfaces of both the first base member 11 and the second base member 12. However, in the invention, the film may be formed on the main surface of one of the first base member 11 and the second base member 12.

Further, in the first embodiment and the second embodiment, when the thickness d of the bonding layer 13 is obtained from the relational expressions, the expression (2) of −0.1≦α≦0.2, not the expression (2A) of −0.1≦α≦0.1, may be used.

The invention can be used for the wavelength plate, the optical element for laser processing, and other optical elements.

The entire disclosure of Japanese Patent Application No. 2010-093740, filed Apr. 15, 2010 and Japanese Patent Application No. 2011-044336, filed Mar. 1, 2011 are expressly incorporated by reference herein.

1. An optical element comprising:
a first base member having transparency;
a second base member having transparency; and
a bonding layer that bonds the first base member and the second base member and is provided by a plasma polymerizing method, wherein the bonding layer includes a Si skeleton that contains a siloxane (Si—O) bond, and an elimination group that binds to the Si skeleton, and
when a thickness of the bonding layer is d, a wavelength of transmitted light is λ, and a refractive index of the bonding layer at the wavelength λ is n, following expressions are satisfied:
n×d/λ={(M+1)/2}+α (1)
−0.1≦α≦0.2 (2)
where, M is a natural number.

2. The optical element according to claim 1, wherein the elimination group being an organic group.

3. The optical element according to claim 1, wherein the bonding layer includes a Si skeleton having a crystallinity of 45% or less.

4. The optical element according to claim 1, wherein the bonding film bonds the first base member and the second base member by an active hand, wherein the active hand is a non-bonding hand of a silicon atom of a Si-skeleton where elimination group removes from the silicon atom of the Si-skeleton.

5. The optical element according to claim 3, wherein the bonding film bonds the first base member and the second base member by an active hand, wherein the active hand is a non-bonding hand of a silicon atom of a Si-skeleton where elimination group removes from the silicon atom of the Si-skeleton.

6. The optical element according to claim 1, wherein each of the first base member and the second base member has a birefringence.

7. The optical element according to claim 3, wherein each of the first base member and the second base member has a birefringence.

8. The optical element according to claim 1, wherein each of the first base member and the second base member is made of quartz crystal.

9. The optical element according to claim 3, wherein each of the first base member and the second base member is made of quartz crystal.

10. The optical element according to claim 1, wherein when the wavelength λ is in a 405 nm band, and the refractive index n is 1.5269, M is one of 0, 1 and 2.

11. The optical element according to claim 1, wherein when the wavelength λ is in a 660 nm band, and the refractive index n is 1.4950, M is one of 0 and 1.

12. The optical element according to claim 1, wherein when the wavelength λ is in a 785 nm band, and the refractive index n is 1.4944, M is 0.

13. The optical element according to claim 1, wherein when the wavelength λ is in a 354 nm band, and the refractive index n is 1.5899, M is one of 1, 2 and 3.

14. The optical element according to claim 1, wherein when the wavelength λ is in a 532 nm band, and the refractive index n is 1.4982, M is one of 0 and 1.

15. The optical element according to claim 1, wherein when the wavelength λ is in a 1064 nm band, and the refractive index n is 1.4943, M is 0.

16. The optical element according to claim 1, wherein when the wavelength λ is in a 308 nm band, and the refractive index n is 1.7800, M is one of 2, 3 and 4.
